(19) United States
(12) Patent Application Publication
(10) Pub. No.: US 2025/0014090 A1
(43) Pub. Date: Jan. 9, 2025

(54) SYSTEM AND METHOD FOR PERSONALIZED RETAIL WITH SMART GLASSES

(71) Applicant: VEROFAX LIMITED, ABU DHABI (AE)

(72) Inventor: Wassim WERHEBY, ABU DHABI (AE)

(21) Appl. No.: 18/889,426

(22) Filed: Sep. 19, 2024

Related U.S. Application Data
(63) Continuation-in-part of application No. PCT/IB2023/052797, filed on Mar. 22, 2023.
(60) Provisional application No. 63/583,589, filed on Sep. 19, 2023.
(60) Provisional application No. 63/324,109, filed on Mar. 27, 2022.

(51) Int. Cl. G06Q 30/0601; G06Q 30/0202

(52) U.S. Cl. CPC G06Q 30/0631; G06Q 30/0202

(57) ABSTRACT

A system and method which enables a buyer to view information about a product and/or to purchase the product through smart glasses or other visual augmentation technology, for an augmented and/or automated retail experience. The user views at least a portion of the container with a camera. Upon scanning that portion of the container, for example to scan a QR code, a web page or other user interface appears on a communication device that is in communication with the camera, such as the previously described smartphone or other mobile communication device, and/or smart glasses or other visual augmentation technology. If the user wishes to purchase the product, such a purchase may be performed through the previously described smartphone or other mobile communication device, and/or smart glasses or other visual augmentation technology.

### FIELD OF THE INVENTION

The present invention is of a system and method for automating and augmenting the retail experience, and in particular, to such a system and method which enables a buyer to view personalized information about a product and/or to purchase the product through smart glasses or other visual augmentation technology.

### BACKGROUND OF THE INVENTION

A number of solutions have been proposed for a more streamlined retail experience for physical, “bricks and mortar” stores. For example, Amazon has set up special retail stores with technology that enables automated checkout and payment. However, such technology is difficult to implement in larger stores, and in any case, may not be suitable to retrofit existing retail stores.

Furthermore, physical retail stores also want to offer a more personalized and interesting shopping experience, given the prevalence and ease of online shopping. However, adding new technology to existing physical stores can be difficult and costly.

### BRIEF SUMMARY OF THE INVENTION

The present invention overcomes the drawbacks of the background art by providing a system and method for physical store purchases of physical products which provides a streamlined retail experience, by enabling users to purchase products through obtaining an image of the product. Such a system and method further overcome drawbacks of the background art by enabling existing physical stores to be easily retrofitted for such purchases.

The present invention, in at least some embodiments, is of a system and method which enables a buyer to view information about a product and/or to purchase the product through smart glasses or other visual augmentation technology, for an augmented and/or automated retail experience. The user views at least a portion of the container with a camera, such as for example the camera of a smartphone or other mobile communication device, and/or smart glasses or other visual augmentation technology. Upon scanning that portion of the container, for example to scan a QR code, a web page or other user interface appears on a communication device that is in communication with the camera, such as the previously described smartphone or other mobile communication device, and/or smart glasses or other visual augmentation technology. The user may then interact with the web page or other user interface, for example to receive more information about the product. If the user wishes to purchase the product, such a purchase may be performed through the previously described smartphone or other mobile communication device, and/or smart glasses or other visual augmentation technology. The user may even leave the store with the product upon receiving a confirmation of purchase, such as an exit code for example.

Although reference is made herein to a “container”, it is understood that the embodiments as described herein may also apply to products that may not be sold in a container, such as produce, garments, smaller objects or bulk items for example. Computer vision and machine learning algorithms may be applied, to recognize and process objects based on their visual characteristics. Such visual characteristics are also described as visual markers herein. The visual recognition capabilities are leveraged to identify and classify the items. These capabilities may comprise recognizing distinctive features like shape, color, texture, and size. Additionally, AI-driven image analysis may be used to determine the specific type or variety of the produce or item. In the case of bulk items, this analysis is preferably able to estimate quantities or weights based on the visual data.

Optionally and preferably information about the product, including but not limited to one or more of a recorded purchase, a question about the product, a reason for rejecting the product (if the user chooses not to buy), or other information about the user-product interaction, is written to a distributed ledger technology (DLT) such as for example the blockchain.

The user interface may support an AR (augmented reality) experience for example. The product may comprise for example any consumable product in a container, including but not limited to food, beverage, medicine, cosmetics, personal care products, household care products, and other consumer products. Optionally, the product may comprise an item not in a container, including but not limited to clothing, fresh fruit and vegetables, furniture, household goods, fashion accessories, shoes and the like. If the item is not in the container, it may be identified through an NFC tag, analysis of an image containing the item, a QR code or another visual marker on the item or associated with the item, and the like.

Each product, type of product, product category or other product-related designation preferably receives a unique code. Such a code may be a QR code or other code. The code is preferably added to the product after being assigned, for example by being printed on the container for the product, added as a sticker or otherwise included with the product.

According to at least some embodiments, the code such as the QR code relates to a unique web address and to a Blockchain based repository for the container. Optionally the code is unique for each individual container, and/or each type of container and so forth. Optionally the blockchain based repository stores a record of one or more data items related to that container, such as for example purchase by a user; inventory ownership by supply chain stakeholder based on validated receipts; certificates that are validated and signed by a trusted party, including but not limited to the manufacturer, a quality assurance body and/or the issuer of certificate; and/or optionally differing content to be shared with each stakeholder based on customized role interactions UI/UX.

The data is preferably stored in public access containers and private access containers, requiring credentials based on role access from the owner of the product that is allowed to grant access (as a non-limiting example, the manufacturer or brand owner).

According to at least some embodiments, there is provided a system and method for supporting an automation solution for a retail store with the application of smart serialization, computer vision, and a web application. Without wishing to be limited by a closed list, such an automation solution may optimize the checkout process, lower freshness cost, and reduce the cost and complexity of replenishment management. Every item available for purchase, described herein also as a “product” or “container”, is preferably serialized on the platform and each item will have a unique identifier generated on the product in the form of a code, such a QR code or an NFC tag. Every serialized item preferably has a unique web address. Product Information is accessed as public and private data fields defined based on the access user has for each item.

The system as described herein ensures the accuracy of product information provided to the user through a combination of advanced technologies and data verification processes such as computer vision and image recognition. The system utilizes computer vision and image recognition algorithms to identify and analyze product labels, product images, bar codes or QR codes, as described herein. For example, the analysis may comprise OCR (optical character recognition), shapes, colors, geometric placement and so forth. The system preferably connects to a cloud-based database that stores a vast repository of product information, including ingredients, usage instructions, brand messages, reviews, lab reports, recycling and sustainability information, and safety warnings. This database is regularly updated to maintain accuracy. Before displaying product information to the user, the system preferably cross-references the scanned code or image with the database to verify the accuracy of the data. Optionally, the system may also check with third parties to verify the information, for example regarding nutritional claims, safety information, reviews, and/or recycling and sustainability information.

The backend of the system as described herein may integrate directly with manufacturers or supplier databases, or APIs, to access the most up-to-date and authoritative information about their products. This direct link minimizes the chances of outdated or incorrect data. By combining these elements, the system maintains a high level of accuracy in delivering product information to users, thereby enhancing their shopping experience and ensuring they have access to reliable and up-to-date details about the products they encounter.

The application interface through a device such as a smartphone or smart glasses helps the user to visualize the products. Smart glasses can work even in average brightness, ensuring a vivid and sharp visual display in different lighting conditions. Smart glasses are an assisted reality device that fits onto specially designed frames and uses a micro projector to overlay various kinds of information directly in front of the eyes of the user.

Users can scan the code with smart glasses, which preferably then automatically recognizes the product. The smart glasses may provide different options to the users on the micro projector screen such as learning more about the product, checking for product composition or ingredient list, understanding how to use the product, and then optionally adding it to a cart and completing the checkout process seamlessly. Smart glasses preferably support four different user interactions through touch, voice, head movement, and hand motion, allowing users to have faster and easier access to the information they need. This technology reduces the time customers spend waiting in line at the counter to checkout.

As described herein, optionally such smart glasses may be replaced and/or supported by another type of visualization technology, including but not limited to a smartphone or other mobile device, preferably one with a camera.

The system as described herein is preferably able recognize the QR code printed on the container during bulk purchases or when the user is buying more than one of same product. Such recognition may occur through a user app on a smartphone or other mobile device, and/or through smart glasses or other visualization devices, and/or through analysis at a remote server. Although reference is made herein to “QR code”, it is understood that the system may analyze the product according to one or more of product labels, product images, bar codes or QR codes.

When a user is purchasing any product, by viewing the product the user can avail himself of any of the user interaction methods mentioned above. When purchasing more than one product, instead of scanning every item separately, an associated app may suggest having the user place the products in stack/position them in such a way, such that the smart glass may scan the QR codes, convert the images into text and recognize all the different QR codes in at once. If any carton or pallet is added to the cart, the application is preferably able to recognize the total number of products that are in the carton and shows to the user. Once products are added to the cart, users are preferably able to validate the product and remove any product that is not required.

Cameras in store are preferably integrated with computer vision to monitor and track the behaviors of each user and validate their purchase. Weight sensors on shelves preferably detect if a user is selecting more of a product or a heavier product than what has been added to the online purchase card. Both computer vision and weight sensors may trigger an alert in case of any issues detected, after which the application preferably guides the user to go to a physical checkout counter. All the alert and notifications are preferably displayed on the micro projector screen of smart glasses or alternatively on a smartphone or other mobile device.

The retailer and the user (customer) optionally and preferably each have a wallet which is used to pay for the items purchased. Every retailer has a wallet which contains the items in store. The user (consumer) also preferably has a wallet, and the items purchased by him are added to the wallet where they can complete the payment processing. Once the payment is successful, transfer of ownership of the goods is done from retailer to customer and user receives some type of proof purchase, such as an invoice QR code generated in the platform.

The invoice code preferably has at least the following information: items purchased, status of payment and the confirmation code or alert code from the computer vision API integrated in cameras and the sensors on the shelf of retail store. sensors are under the shelf, and it is calculating the weight currently on the shelf and after user has picked up an item and in real time how much was paid for it, the sensor data is constantly sent to retail store backend for validating the purchase. The output code from computer vision API will be True or False. The code is True, when the User has exactly picked the items from shelf which he added in the application cart; the items in both Trolley and Application cart are same. If the payment code is identified as false, such that the user has not in fact paid, the user is instructed to go to physical checkout counter to verify the items and check out.

The invoice is sent to the user, for example through their registered email id with Walkthrough QR code which is preferably scanned in the exit gate. The integration with Retailer backend system will verify the code, validate the inventory, and then open the Gate for users to exit the store. In case of any discrepancy, Application guides the customer to go to physical checkout counter for staff to help them and complete the checkout process. Reconciliation of inventory is made easier with a unique item identifier to detect consumer pilferage. It also helps retailers by effective inventory management, increased shopper's insights by providing customized shopping experiences, lowering the freshness cost, improve their overall merchandising and ranging of the products based on granular analytics they get from the platform.

The application may also allow the user to continue shopping even after the order is completed. If the user has completed the purchase and he/she is still inside the retailer store, the user can continue to do the shopping, and the invoice will be updated with the new set of items purchased. The above scenario may be applicable only if the user is still in the retailer store and does not exit the gate. If the user has exited the gate but still wants to purchase more items, it is preferably considered as a new order.

According to at least some embodiments, the system as described herein uses Blockchain technology for product serialization and the transactional data is stored on an immutable blockchain ledger. This provides a secure environment to avoid any fraud during purchase. Each product added to the platform is stored in a blockchain. As a database, blockchain stores information electronically in a digital format. Without wishing to be limited by a closed list, one advantage of blockchain is to allow digital information to be recorded and distributed, but not edited. In this way, blockchain is the foundation for immutable ledgers, or records of transactions that cannot be altered, deleted, or destroyed. Computer vision enables the system to derive information from digital images captured during scanning and take required actions based on that information.

According to at least some embodiments, there is provided a system for automated purchase of a physical product from a retail store, comprising a user computational device for obtaining an image of the physical product contained within the retail store; a server for receiving said image from said user computational device; and a security system in the retail store for securing said physical product against unauthorized removal from the store; each of said server and said user computational device comprising a memory for storing instructions and a processor for executing said instructions; upon execution of instructions by said processor in said user computational device to request a purchase of said physical product, and authorization of said purchase by execution of instructions by said processor in said server, said security system permits removal of said product from the retail store.

Optionally, said processor of said server executes instructions to: identify said container according to an analysis of said image; receive a payment request from said user computational device; and determine whether said payment request is completed, and if so, notifying said security system. Optionally, said user computational device comprises a mobile telephone, said mobile telephone comprising a camera and a mobile app, and said camera of said mobile telephone scans said physical product to obtain said image, such that said mobile app transmits said image to said server. Optionally, said mobile app is in communication with a payment modality and said payment request is performed through said payment modality. Optionally, said user computational device comprises smart glasses, said smart glasses comprising a camera, said camera of said smart glasses scans said physical product to obtain said image. Optionally, said user computational device further comprises said mobile telephone and said image from said smart glasses is sent through said mobile telephone. Optionally, said smart glasses further comprise a communication module and said smart glasses communicate directly with said server. Optionally, said image comprises a code and said server determines that said physical product has been purchased according to said code. Optionally, said code comprises a QR code or an NFC tag.

Optionally, the retail store comprises a secured exit and said security system permits removal of an authorized purchase through said security exit. Optionally, said security system further comprises a security system computational device, a computer vision system and a shelf weight sensor, said security system computational device comprises a memory for storing instructions and a processor for executing said instructions; said computer vision system comprises a plurality of cameras for obtaining images within the retail store in regard to customer behavior and activity; said processor of said security system computational device analyzes video data from said computer vision system and product weight data from said shelf weight sensor to determine if a physical product to be purchased has been correctly selected for purchase through said user computational device. Optionally a user selects a plurality of products and said computer vision system detects said plurality of products and determines whether said plurality of physical products to be purchased has been correctly selected for purchase through said user computational device.

The system of claim 12, said user selects a container with multiple products and wherein said computer vision system detects said multiple products in said container, and determines whether said multiple products to be purchased have been correctly selected for purchase through said user computational device. Optionally additional information about the product is requested through said user computational device and is provided by said server according to said image. Optionally said additional information is stored through distributed ledger technology (DLT) and is read from said DLT by said server. Optionally said additional information comprises one or more of a previously recorded purchase, an answer to a question about the product and a reason for rejecting the product. Optionally said additional information is obtained by providing an image comprising an item selected from the group consisting of a code, an identifier, a product shape and a marker; and wherein said processor of said server executes instructions to cause an interface to be provided to said user computational device; wherein said processor of said user computational device executes instructions to cause a user interface to be displayed. Optionally said user interface comprises a web page, an augmented reality display or a verbal display. Optionally a user interacts with said user interface to obtain more information about said physical product. Optionally said processor of said user computational device executes instructions for displaying a user interface, and wherein a user performs actions to purchase said physical product through said user interface. Optionally said product comprises one or more of food, beverage, medicine, cosmetics, personal care products, household care products, clothing, fresh fruit and vegetables, furniture, household goods, fashion accessories, or shoes. Optionally said DLT comprises a blockchain and wherein said product is associated with a unique web address and to a blockchain based repository for said product. Optionally said product is contained in a container, and wherein a unique identifier is associated with each individual container.

Optionally said unique identifier is associated with said blockchain based repository and wherein said blockchain based repository stores a record of one or more data items related to that container, comprising or more of purchase by a user; inventory ownership by supply chain stakeholder based on validated receipts; certificates that are validated and signed by a trusted party; and content suitable for each stakeholder according to customized role interactions for said stakeholder. Optionally said trusted party comprises one or more of a manufacturer of said product, a quality assurance body for a type of said product; an issuer of certificate associated with said type of said product, or a combination thereof. Optionally said user computational device further comprises access to a wallet for purchasing said physical product, and wherein said security system computational device further comprises access to a wallet for receiving payment for said physical product. Optionally upon a successful purchase of said product, said user computational device receives a receipt, comprising a proof of purchase; and wherein said security system permits said product to be removed from the retail store upon scanning of said receipt. Optionally said receipt further comprises a list of items purchased, status of payment and a confirmation code from said security system, in regard to confirmation of said items purchased. Optionally if a user completes purchase of said product but remains within the retail store, an additional product may be purchased and included within said receipt.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Unless otherwise defined, all technical and scientific terms used herein have the same meaning as commonly understood by one of ordinary skill in the art to which this invention belongs. The materials, methods, and examples provided herein are illustrative only and not intended to be limiting.

An algorithm as described herein may refer to any series of functions, steps, one or more methods or one or more processes, for example for performing data analysis.

Implementation of the apparatuses, devices, methods and systems of the present disclosure involves performing or completing certain selected tasks or steps manually, automatically, or a combination thereof. Specifically, several selected steps can be implemented by hardware or by software on an operating system, of a firmware, and/or a combination thereof. For example, as hardware, selected steps of at least some embodiments of the disclosure can be implemented as a chip or circuit (e.g., ASIC). As software, selected steps of at least some embodiments of the disclosure can be implemented as a number of software instructions being executed by a computer (e.g., a processor of the computer) using an operating system. In any case, selected steps of methods of at least some embodiments of the disclosure can be described as being performed by a processor, such as a computing platform for executing a plurality of instructions. The processor is configured to execute a predefined set of operations in response to receiving a corresponding instruction selected from a predefined native instruction set of codes.

Software (e.g., an application, computer instructions) which is configured to perform (or cause to be performed) certain functionality may also be referred to as a “module” for performing that functionality, and also may be referred to a “processor” for performing such functionality. Thus, a processor, according to some embodiments, may be a hardware component, or, according to some embodiments, a software component.

Further to this end, in some embodiments: a processor may also be referred to as a module; in some embodiments, a processor may comprise one or more modules; in some embodiments, a module may comprise computer instructions-which can be a set of instructions, an application, software-which are operable on a computational device (e.g., a processor) to cause the computational device to conduct and/or achieve one or more specific functionality.

Some embodiments are described with regard to a “computer,” a “computer network,” and/or a “computer operational on a computer network.” It is noted that any device featuring a processor (which may be referred to as “data processor”; “pre-processor” may also be referred to as “processor”) and the ability to execute one or more instructions may be described as a computer, a computational device, and a processor (e.g., see above), including but not limited to a personal computer (PC), a server, a cellular telephone, an IP telephone, a smart phone, a PDA (personal digital assistant), a thin client, a mobile communication device, a smart watch, head mounted display or other wearable that is able to communicate externally, a virtual or cloud based processor, a pager, and/or a similar device. Two or more of such devices in communication with each other may be a “computer network.”

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the drawings:

FIGS. 1A-1C show non-limiting, exemplary, illustrative systems for supporting augmented retail interactions for a product;

FIG. 2 shows a non-limiting, exemplary, illustrative method for interacting with the system of any of FIGS. 1A-1C;

FIG. 3 shows a non-limiting, exemplary, illustrative analysis engine for the system of any of FIGS. 1A-1C;

FIGS. 4A-4D show a non-limiting, exemplary flow for interactions with the augmented retail system as described herein;

FIG. 5 shows a non-limiting, exemplary set of microservices for supporting the augmented retail system as described herein;

FIGS. 6A and 6B show other non-limiting, exemplary systems for supporting augmented retail interactions for a product;

FIGS. 7A-7I show another non-limiting, exemplary flow for interactions with the augmented retail system as described herein;

FIGS. 8A and 8B show yet another non-limiting, exemplary flow for interactions with the augmented retail system as described herein;

FIGS. 9A and 9B show another non-limiting exemplary system (FIG. 9A) and data flow (FIG. 9B) for interactions with the augmented retail system as described herein;

FIGS. 10A and 10B show a non-limiting exemplary system for AI supported retail personalization;

FIG. 11 shows a non-limiting, exemplary flow for interactions with the augmented retail system as described herein;

FIGS. 12A-13B show non-limiting, exemplary dashboards for analyzing AI supported retail personalization; and

FIG. 14 shows a non-limiting, exemplary method for training an AI model.

### DESCRIPTION OF AT LEAST SOME EMBODIMENTS

Any suitable blockchain which involves a distributed ledger, which preferably requires some type of cryptography, more preferably a public/private key encryption system, or hash or digital signatures, may optionally be used. Once a change—such as for example tracking the state of the container and determining an updated state—is made and is written to the distributed ledger, this change is automatically securely, non-falsifiably, that is completely accurately, replicated to all network participants.

The nature of the distributed ledger is such that all parties to a transaction can see the details of the transaction and optionally further requirements for the transaction to be complete.

Such a distributed ledger would also have the advantage of fraud prevention with immutable, append-only Distributed Ledger Technology. For example, users attempting to fraudulently trade cryptocurrency units that they do not possess would be blocked.

A blockchain or blockchain is a distributed database that maintains a list of data records, the security of which is enhanced by the distributed nature of the blockchain. A blockchain typically includes several nodes, which may be one or more systems, machines, computers, databases, data stores or the like operably connected with one another. In some cases, each of the nodes or multiple nodes are maintained by different entities. A blockchain typically works without a central repository or single administrator. One well-known application of a blockchain is the public ledger of transactions for cryptocurrencies such as used in bitcoin. The data records recorded in the blockchain are enforced cryptographically and stored on the nodes of the blockchain.

A blockchain provides numerous advantages over traditional databases. A large number of nodes of a blockchain may reach a consensus regarding the validity of a transaction contained on the transaction ledger. Similarly, when multiple versions of a document or transaction exits on the ledger, multiple nodes can converge on the most up-to-date version of the transaction. For example, in the case of a virtual currency transaction, any node within the blockchain that creates a transaction can determine within a level of certainty whether the transaction can take place and become final by confirming that no conflicting transactions (i.e., the same currency unit has not already been spent) confirmed by the blockchain elsewhere.

The blockchain typically has two primary types of records. The first type is the transaction type, which consists of the actual data stored in the blockchain. The second type is the block type, which are records that confirm when and in what sequence certain transactions became recorded as part of the blockchain. Transactions are created by participants using the blockchain in its normal course of business, for example, when someone sends cryptocurrency to another person), and blocks are created by users known as “miners” who use specialized software/equipment to create blocks. Users of the blockchain create transactions that are passed around to various nodes of the blockchain. A “valid” transaction is one that can be validated based on a set of rules that are defined by the particular system implementing the blockchain. For example, in the case of cryptocurrencies, a valid transaction is one that is digitally signed, spent from a valid digital wallet and, in some cases, which meets other criteria. In some blockchain systems, miners are incentivized to create blocks by a rewards structure that offers a pre-defined per-block reward and/or fees offered within the transactions validated themselves. Thus, when a miner successfully validates a transaction on the blockchain, the miner may receive rewards and/or fees as an incentive to continue creating new blocks.

Preferably the blockchain(s) that is/are implemented are capable of running code, to facilitate the use of smart contracts. Smart contracts are computer processes that facilitate, verify and/or enforce negotiation and/or performance of a contract between parties. One fundamental purpose of smart contracts is to integrate the practice of contract law and related business practices with electronic commerce protocols between people on the Internet. Smart contracts may leverage a user interface that provides one or more parties or administrators access, which may be restricted at varying levels for different people, to the terms and logic of the contract. Smart contracts typically include logic that emulates contractual clauses that are partially or fully self-executing and/or self-enforcing. Examples of smart contracts are digital rights management (DRM) used for protecting copyrighted works, buying or selling goods, whether or virtual or physical, executing transfers of goods or of rights associated with such goods, and the like.

Smart contracts may also be described as pre-written logic (computer code), stored and replicated on a distributed storage platform (e.g. a blockchain), executed/run by a network of computers (which may be the same ones running the blockchain), which can result in ledger updates (transfer of digital rights, etc.).

Smart contract infrastructure can be implemented by replicated asset registries and contract execution using cryptographic hash chains and Byzantine fault tolerant replication. For example, each node in a peer-to-peer network or blockchain distributed network may act as a title registry and escrow, thereby executing changes of ownership and implementing sets of predetermined rules that govern transactions on the network. Each node may also check the work of other nodes and in some cases, as noted above, function as miners or validators.

Not all blockchains can execute all types of smart contracts. For example, Bitcoin cannot currently execute smart contracts. Sidechains, i.e. blockchains connected to Bitcoin's main blockchain could enable smart contract functionality: by having different blockchains running in parallel to Bitcoin, with an ability to jump value between Bitcoin's main chain and the side chains, side chains could be used to execute logic. Smart contracts that are supported by sidechains are contemplated as being included within the blockchain enabled smart contracts that are described below.

For all of these examples, security for the blockchain may optionally and preferably be provided through cryptography, such as public/private key, hash function or digital signature, as is known in the art.

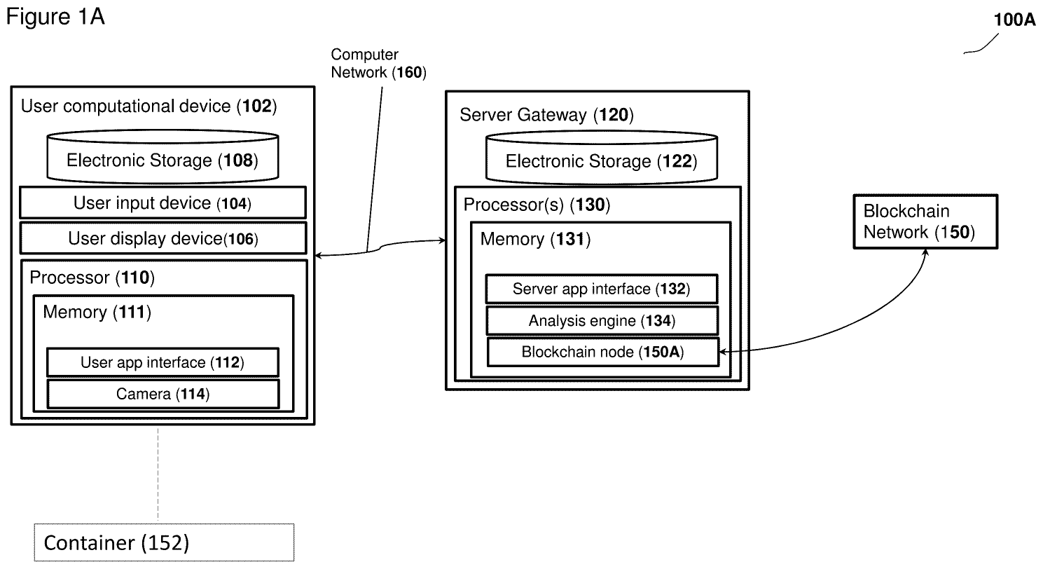

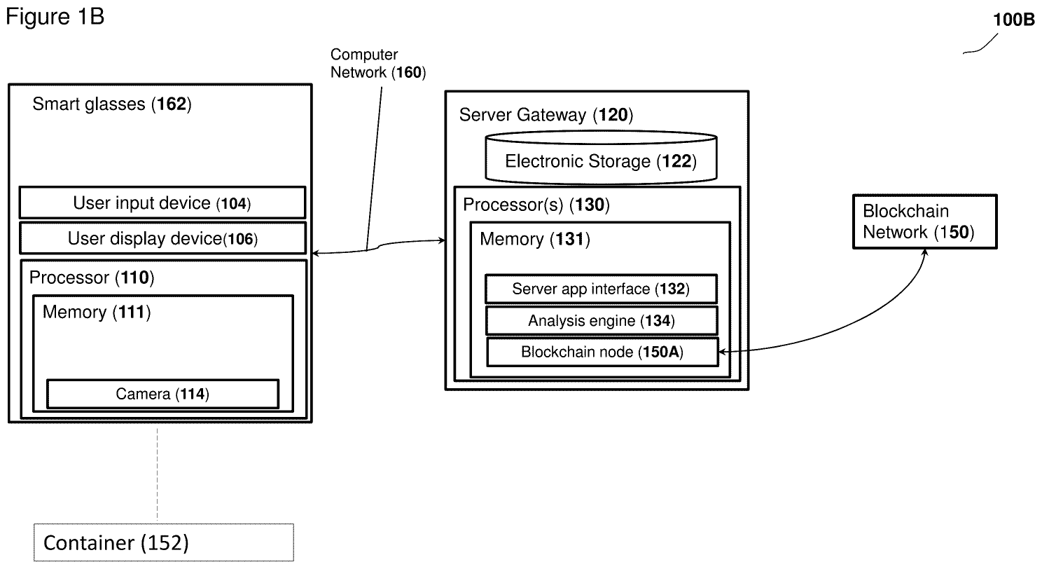

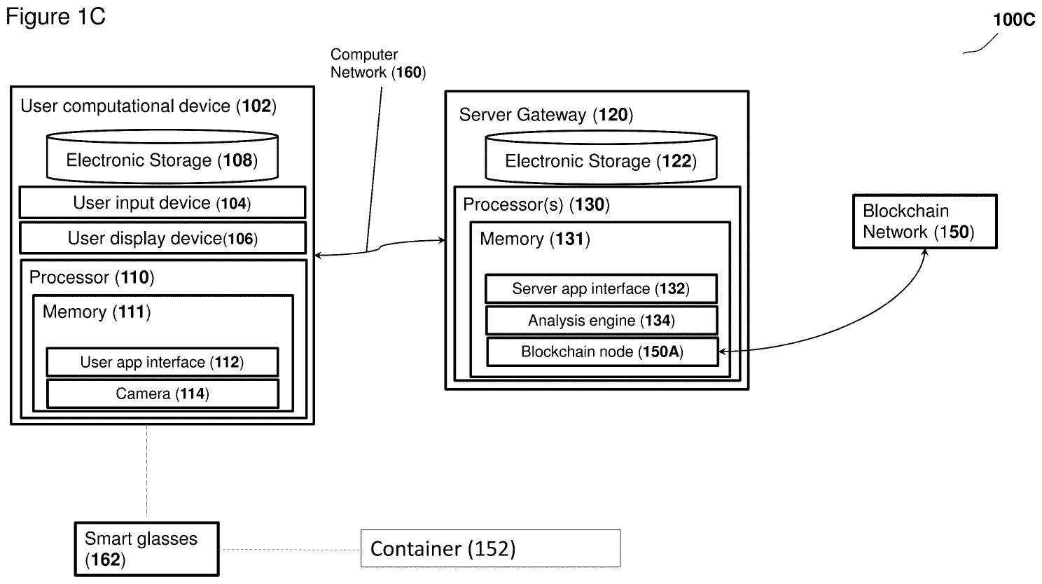

Turning now to the figures, FIGS. 1A-1C show non-limiting, exemplary, illustrative systems for supporting augmented retail interactions for a product.

As shown with regard to FIG. 1A, a system 100A features a user computational device 102 that communicates with a server gateway 120 through a computer network 160. In this implementation, server gateway 120 supports direct reading information from, and storing information on, a blockchain network 150. Server gateway 120 communicates with a container 152, which may for example contain any suitable product, for example as described herein. Container 152 preferably features a QR code and/or other detectable information on at least a portion thereof. Such information is preferably communicable as an image to server gateway 120. Such communication may be provided through a direct communication channel and/or indirectly. Preferably, such communication is supported by user computational device 102 as described in greater detail below.

Server gateway 120 preferably analyzes such communication and then locates the price and other relevant information about container 152, whether from electronic storage 122 and/or blockchain network 150. Blockchain network 150 may be used for example store product details, including product information, attributes and transactional data.

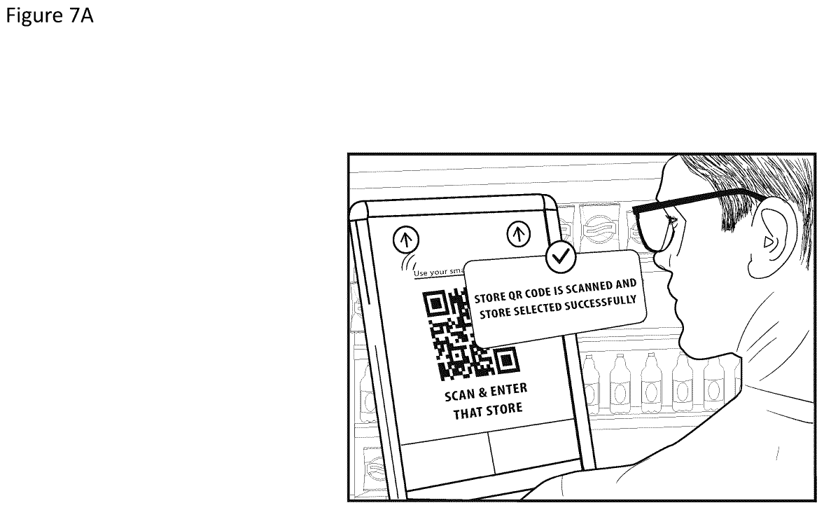

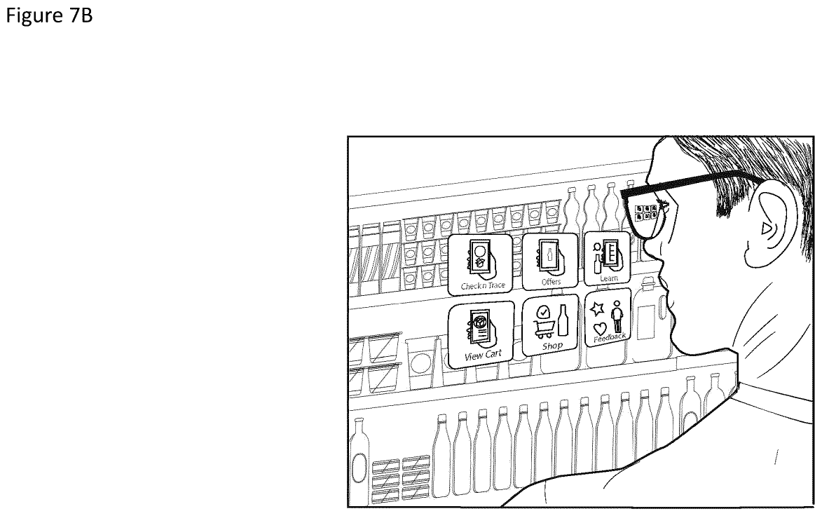

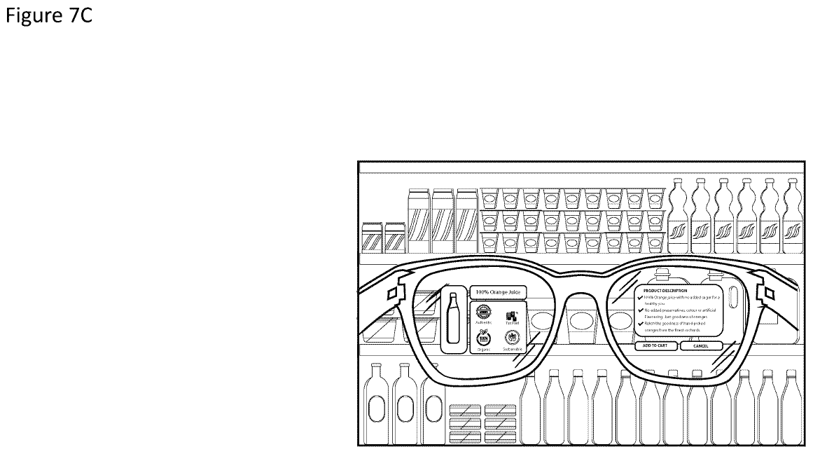

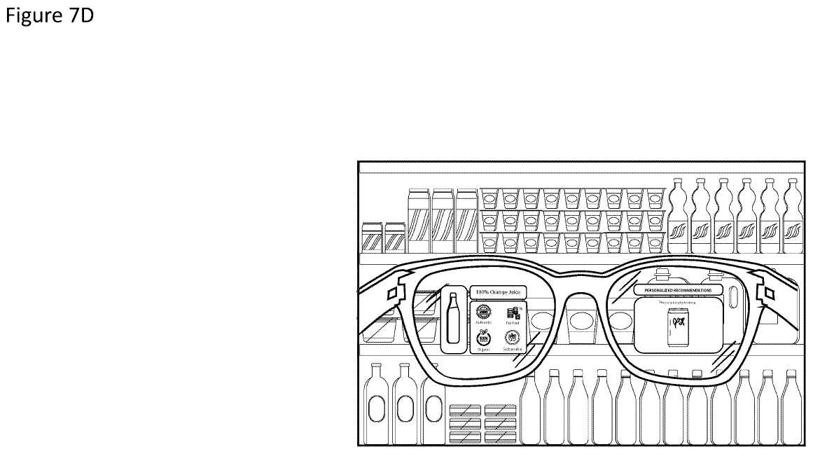

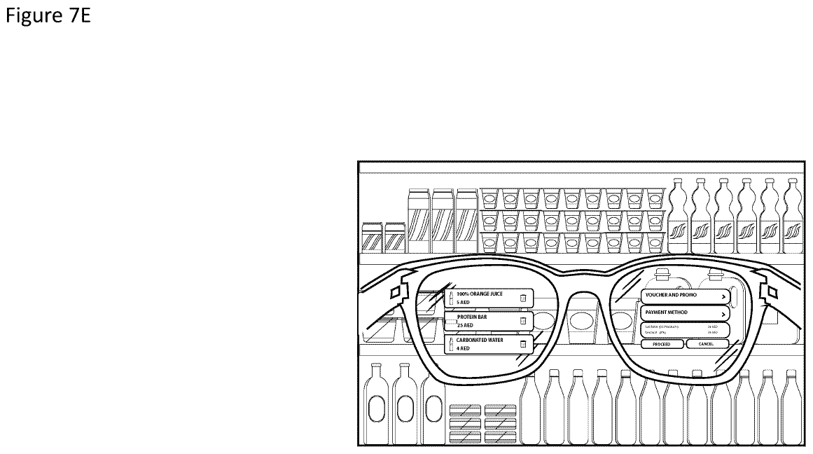

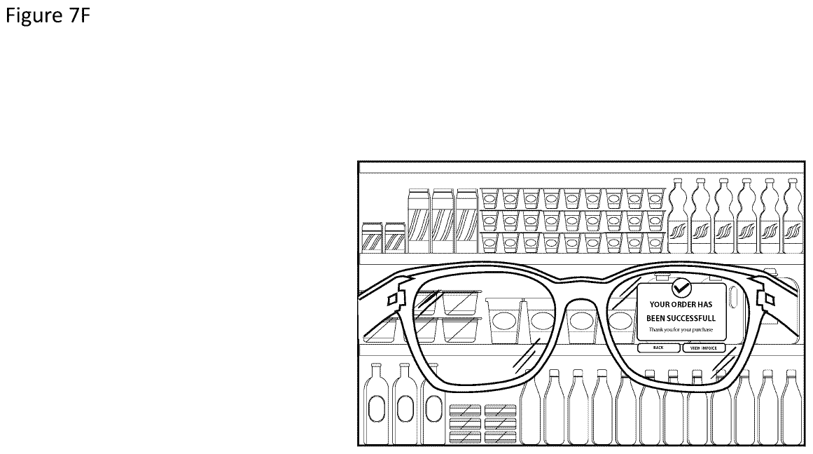

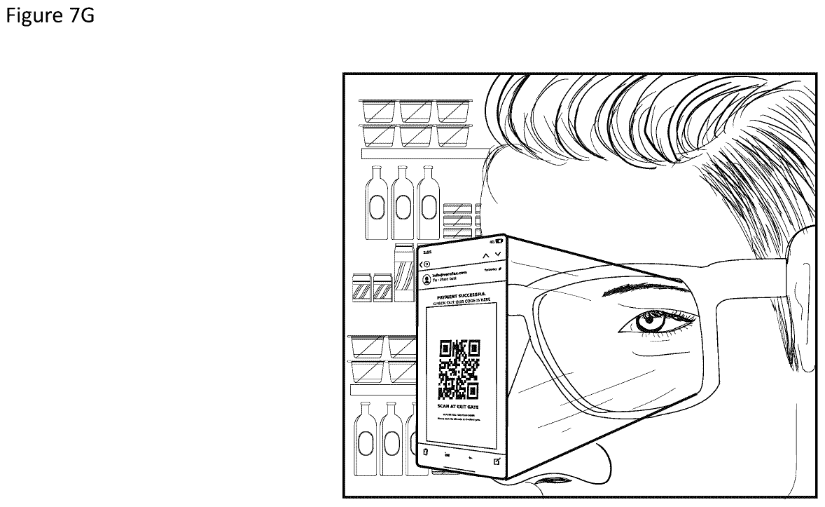

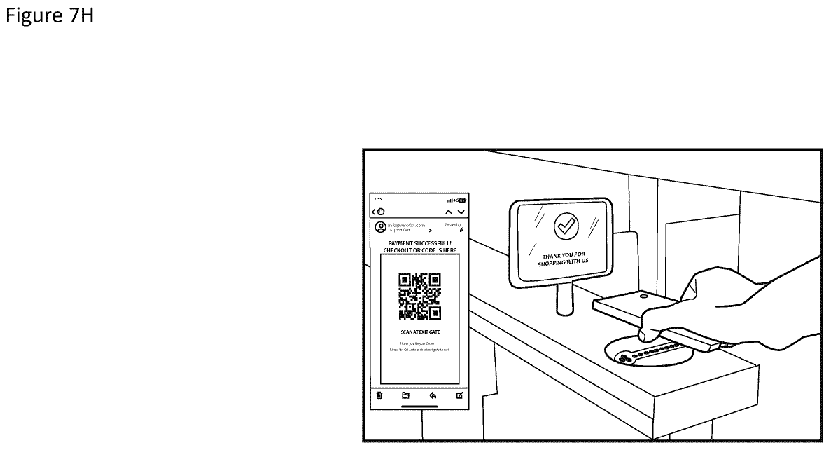

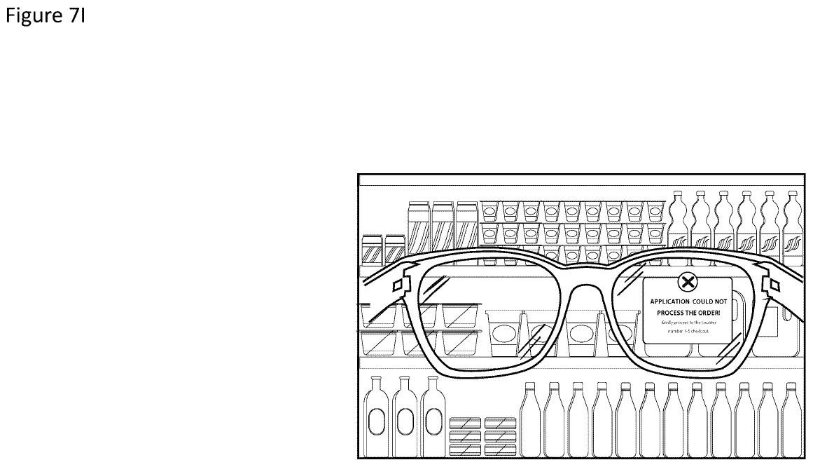

Server gateway 120 may for example read information from and write information to blockchain network 150 through a blockchain node 150A, and/or through a blockchain gateway (not shown). Server gateway 120 may also respond to user computational device 102 regarding container 152, for example to indicate the price of the product or other information about the product contained in container 152. Server gateway 120 may also support provision of a web page or other user interface for an AR (augmented reality) experience, as described for example with regard to FIGS. 7A-7I.

User computational device 102 optionally includes a user input device 104, the user app interface 112, and user display device 106. User input device 104 may optionally be any type of suitable input device including but not limited to a keyboard, microphone, mouse, or other pointing device and the like. Preferably user input device 104 includes a microphone and a keyboard, mouse, or keyboard mouse combination.

User computational device 102 preferably comprises a camera 114 for obtaining one or more images of at least a portion of container 152. Preferably, user computational device 102 comprises a cellular network communication hardware device, which may for example communicate through the cellular network with a SIM card to send the image or images to server gateway 120. For example, user computational device 102 may comprise or may be a smartphone or other mobile cellular device. An analysis engine 134 on server gateway 120 then analyzes the image(s) to identify the code or other information on container 152, so as to identify the product contained therein.

User computational device 102 also preferably comprises a processor 110 and a memory 111. Functions of processor 110 preferably relate to those performed by any suitable computational processor, which generally refers to a device or combination of devices having circuitry used for implementing the communication and/or logic functions of a particular system. For example, a processor may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processor may further include functionality to operate one or more software programs based on computer-executable program code thereof, which may be stored in a memory, such as a memory 111 in this non-limiting example. As the phrase is used herein, the processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Also optionally, memory 111 is configured for storing a defined native instruction set of codes. Processor 110 is configured to perform a defined set of basic operations in response to receiving a corresponding basic instruction selected from the defined native instruction set of codes stored in memory 111. For example and without limitation, memory 111 may store a first set of machine codes selected from the native instruction set for receiving one or more images of at least a portion of container 152 through camera 114, preferably containing a code therein, and a second set of machine codes selected from the native instruction set for transmitting such image(s) to server gateway 120.

Similarly, server gateway 120 preferably comprises processor 130 and memory 131 with machine readable instructions with related or at least similar functions, including without limitation functions of server gateway 120 as described herein. For example and without limitation, memory 131 may store a first set of machine codes selected from the native instruction set for receiving image(s) of container 152 from user computational device 302, a second set of machine codes selected from the native instruction set for executing functions of analysis engine 134, a third set of machine codes selected from the native instruction set for transmitting information about the product contained in container 152 to user computational device 102 according to an analysis of such image(s), and a fourth set of machine codes selected from the native instruction set for storing information about a purchase or other interactions of the user with container 152 on blockchain network 150.

Preferably such interactions, optionally including a purchase by the user, are recorded on a blockchain through a blockchain network 150. Data is stored and managed using blockchain technology, as supported by blockchain network 150. Optionally, the blockchain can run code. As is known in the art, blockchains can perform more complex operations, defined in full-fledged programming languages. However, it is not a requirement for the blockchain to run code in order for the present invention to be implemented. Optionally only a distributed ledger is required, in which information is written that is securely available to all parties through cryptographic access to the distributed ledger.

According to at least some embodiments the blockchain is optionally a public or permissionless blockchain, such as Bitcoin or Ethereum, which is decentralized and which is a blockchain that anyone in the world can read, anyone in the world can send transactions to and expect to see them included if they are valid, and anyone in the world can participate in the consensus process for determining what blocks get added to the chain and what the current state is. As a substitute for centralized or quasi-centralized trust, public or permissionless blockchains are secured by cryptoeconomics—the combination of economic incentives and cryptographic verification using mechanisms such as proof of work or proof of stake.

Alternatively and optionally, the blockchain is a consortium blockchain, such as Hyperledger, where the consensus process is controlled by a pre-selected set of nodes, which for example may optionally be provided or supported by financial institutions and/or by an international consortium of conservation and development organizations. Such a blockchain is partially decentralized.

Optionally, the Hyperledger Fabric blockchain framework implementation is used (details are provided in “Architecture of the Hyperledger Blockchain Fabric” by Christian Cachin, IBM Research—Zurich, July 2016). It is one of the Hyperledger projects hosted by The Linux Foundation. Intended as a foundation for developing applications or solutions with a modular architecture, Hyperledger Fabric allows components, such as consensus and membership services, to be plug-and-play. Hyperledger Fabric leverages container technology to host smart contracts called “chaincode” that comprise the application logic of the system. This framework also includes such features as:
Channels for sharing confidential information
Ordering Service delivers transactions consistently to peers in the network.
Endorsement policies for transactions
CouchDB world state supports wide range of queries
Bring-your-own Membership Service Provider (MSP)

If the blockchain is private or permissioned—that is, centrally controlled by an operating entity to authorize participation—then optionally all members of the system as described by the present invention which need access are provided with cryptographic access, and become members of the private or permissioned blockchain system, such as Hyperledger.

Hyperledger has its own set of protocols and consensus process, which may optionally be used with smart contracts, to prevent fraud through rewriting information.

One of ordinary skill in the art could easily select a distributed ledger and implement it within various embodiments of the present invention, for example according to information provided in “Blockchain Basics: Introduction To Business Ledgers” by Brakeville and Perepa, IBM, May 9, 2016.

For all of these examples, security for the blockchain may optionally and preferably be provided through cryptography, such as public/private key, hash function or digital signature, as is known in the art.

Communication with blockchain network 150 may involve execution of one or more smart contracts (not shown). For example a smart contract may execute if the user indicates, through user app interface 112 for example, that the user wishes to purchase the product contained within container 152 or even that exact container 152. Optionally execution of the smart contract causes server gateway 120 to execute an alarm, for example if the user has not indicated a desire to purchase container 152, yet computer vision technology within the store (not shown) indicates that the user has moved container 152 to a shopping cart, bag or other location that is not the originally shelf.

Optionally, alternatively or additionally, the smart contract executes if the state of container 152 stays within one or more permitted boundaries during a specified period, or alternatively fails to stay within these boundaries. For example, such a specified period corresponds to shipment of a product contained within container 152 or alternatively may correspond to location of container 152 on a store shelf. In the former case, the smart contract may execute to indicate that one or more conditions required for successful shipment of container 152 have been fulfilled.

Image recognition, for example of the shape or other visual features of container 152, and/or preferably a code such as a QR code on container 152, may be performed simultaneously or sequentially.

According to at least some embodiments, the code such as the QR code relates to a unique web address and to a repository on blockchain network 150 for container 152. Optionally the code is unique for each individual container 152, and/or each type of container 152 and so forth. Optionally the code is unique for a category or type of product contained within container 152. Optionally blockchain network 150 stores a record of one or more data items related to container 152, such as for example shipping status; freshness; inventory ownership by supply chain stakeholder based on validated receipts; certificates that are validated and signed by a trusted party, including but not limited to the manufacturer, a quality assurance body and/or the issuer of certificate; and/or optionally differing content to be shared with each stakeholder based on customized role interactions with container 152.

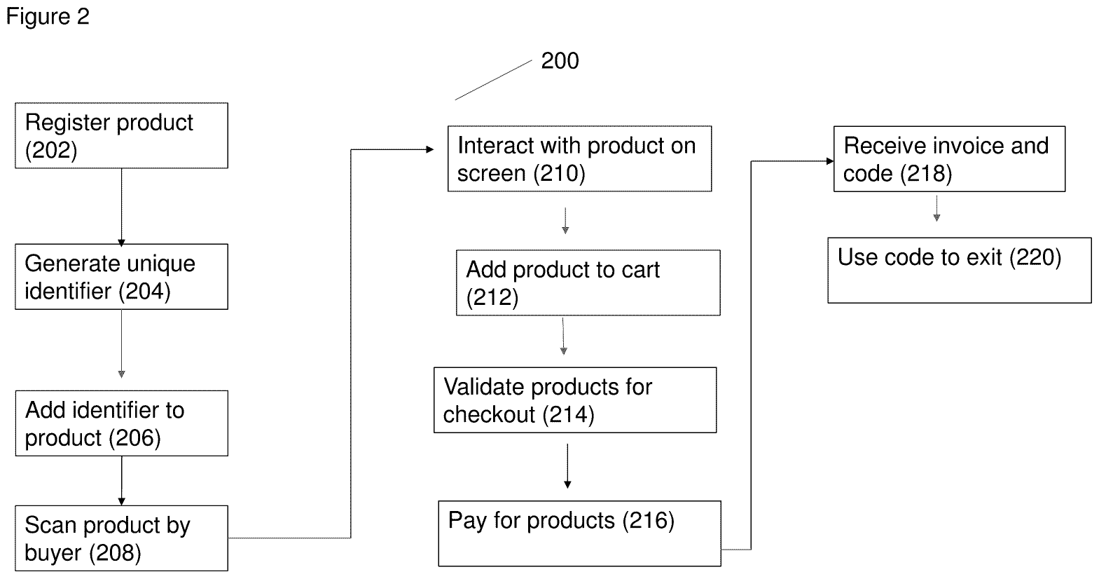

FIG. 1B shows a system 100B, which is similar to the system of FIG. 1A, except that user computational device 102 has been replaced by smart glasses 162. Components with the same reference number have the same or similar functions. As shown with regard to the flow illustrated in FIGS. 7A-7I, the user preferably wears smart glasses 162, which then perform the functions described above with regard to a user computational device, such as a smartphone for example. FIGS. 2 and 7A-7I describe operation of the system when the user is wearing smart glasses 162 in more detail.

FIG. 1C shows a system 100C, which is similar to the systems of FIGS. 1A and 1B, except that both user computational device 102 and smart glasses 162 are present. Components with the same reference number have the same or similar functions. In this configuration, the user may scan or view container 152 with smart glasses 162, but display of product information such as price and other details, and/or indication of a desire to purchase the product, may be made through user computational device 102, smart glasses 162, or both.

The QR code, or other identifier, on container 152, may be scanned by camera 114, smart glasses 162, or both. For example, the QR code may be scanned with smart glasses as described herein. Upon scanning, the QR code or other identifier (such as other visual markers for example) is preferably validated. Furthermore, preferably the unique weblink or unique digital identity is identified, along with the product itself and optionally other characteristics of the product. Computer vision algorithms may be used for such validation and identification. This validation and identification allow users to seamlessly access product information, reviews, and other relevant data by simply looking at the code through smart glasses 162 and/or capturing the code through camera 114. Additionally, real-time translation of text is preferably supported, along with providing contextual information, enhancing the overall user experience. For example, if smart glasses 162 are used, such contextual information may be overlaid on the user's field of view.

Camera 114 may be implemented in a variety of configurations, including but not limited to a camera on a smartphone, smart watch or other mobile device augmented reality (AR) headsets, mixed reality (MR) devices, virtual reality (VR) headsets and the like. Preferably, the configuration features an AR, MR and/or VR implementation. Without wishing to be limited by a closed list, this adaptability provides a consistent and versatile user experience across different visual augmentation platforms, ensuring that users can access our technology regardless of the device they prefer or have access to. It also supports opportunities for future innovations in the field of augmented reality and visual recognition, as the system can serve as a foundation for diverse applications beyond simple smartphones and/or smart glasses.

FIG. 2 shows a non-limiting, exemplary, illustrative method for interacting with the system of any of FIGS. 1A-1C. As shown with regard to a method 200, the process begins at 202, when a product owner or distributor registers the product on the serialization platform. The serialization platform comprises a customizable traceability and serialization engine, which enables product details to be displayed through the smart glasses or other interface. For each product added, the platform preferably generates a digital identity at the item level. Each such identity may for example point to a unique web address so that information may be viewed through a web application for example. Adding such an identity enables traceability of the item throughout the supply chain until purchased by the computer.

At 204, once the products are added, the owner can generate unique identifiers for each item. At 206, the unique identifier is added to each product. For example, a unique QR code may be printed on the product. The code may be unique for that instance of the product, for that type or category of product, for that brand of product, and so forth.

At 208, the buyer (user) preferably scans the product. For example, the user may wear smart glasses and may scan the QR code or other code on the product through these glasses, or through an associated smartphone app. The user may also scan such a code with a smartphone camera. The user then preferably interacts with the product and with information about the product on the corresponding screen, whether the smartphone screen or the smart glasses micro projector screen, at 210.

The scanned product is then added to the application cart with a simple user action like touch, voice, head movement, and hand motion, at 212. If the user is purchasing more than one or a whole carton of the same product, preferably the camera on the smart glasses or smartphone, or an in-store computer vision system, is able to recognize all different QR codes on the products at once and adds them to the cart.

Once added to the application cart, the user is able to validate the products as being present in both a physical shopping trolley and also in the application cart. The user then proceeds to checkout at 214. At 216, the user pays for the products, for example online. The application generates the invoices in the system backend, which are then preferably sent to the user's email. Preferably, payment is made through a compliant and secure payment system, including but not limited to payment processors such as Stripe, PayPal, Apple Pay and Google Pay that adhere to industry-leading security standards. These processors are compliant, ensuring that payment transactions are handled securely.

At 218, the invoice is preferably sent to the user (buyer), for example by email. The invoice preferably includes a code that enables the user to leave the store with the purchases. At 220, the user is able to scan the walkthrough QR code at the exit gate and leave the store.

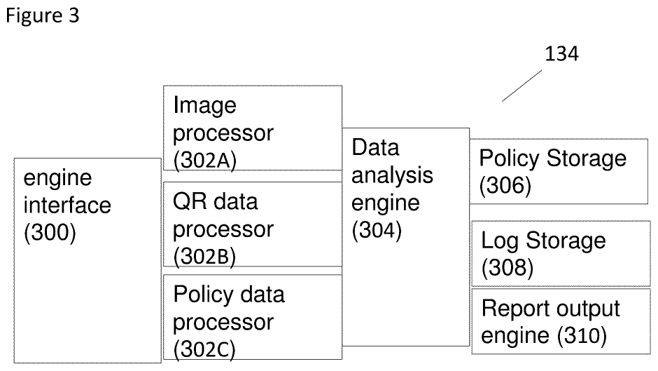

FIG. 3 shows a non-limiting, exemplary, illustrative analysis engine for the system of any of FIGS. 1A-1C. As shown, analysis engine 134 preferably features an engine interface 300 for receiving image(s) of a container from the server and transmitting an analysis and/or other signals to the server (not shown). Analysis engine 134 preferably comprises a plurality of processors 302, shown as image processor 302A, QR data processor 302B and policy data processor 302C for the purpose of illustration only and without any intention of being limiting. Engine interface 300 preferably receives the previously described image(s) of the container (not shown), which are then processed by image processor 302A. Engine interface 300 may receive other image(s) from the container (not shown) in regard to a QR code, which are then processed by QR data processor 302B. Policy information may be retrieved from a policy storage 306 and/or may be transmitted through engine interface 300; in either case, the policy information is preferably analyzed by policy data processor 302C. The policy information may for example determine the different types of suitable reactions by analysis engine 134, including without limitation information about the ingredients or materials of the product, its manufacture, any sustainability or carbon footprint information, freshness, expiration date, safety information, price and so forth.

The various types of processed information are preferably then passed to a data analysis engine 304, which analyzes the information to identify the container, determine the product contained therein, the desired request for further information from the user device and so forth. Data analysis engine 304 may also determine which type of reaction is to be returned, for example to user computational device, which are determined according to policy information processed by policy data processor 302C. For example and without limitation, data analysis engine 304 may determine that the container is on sale and hence that a lower price is to be provided.

The determinations of data analysis engine 304 may be stored in a log storage 308 and/or output through a report output engine 310.

Data analysis engine 304 may also comprise an AI model as is known in the art for image processing and analysis, for example. Optionally, additionally or alternatively, AI model may comprise a neural network, implemented as a very simple feedforward network with one hidden layer. It takes the flattened image as input, and predicts the parameters of the bounding box (i.e. the coordinates x and y of the lower left corner, the width w and the height h). During training, a regression of the predicted to the expected bounding boxes may be performed.

The AI model may for example be able to not only handle QR codes or other visual markers when intact, but also when such QR codes or other visual markers on products are damaged or obscured. When an image captured by a camera and/or smart glasses as described herein features a damaged or partially obscured code, the AI model which is trained with images with different backgrounds and angles leverages advanced image recognition and reconstruction techniques. It can analyze the available visual data, even if it's incomplete or distorted, and intelligently reconstruct the code to the best of its ability. This AI-assisted approach ensures that users can still access relevant information or interact with the product, even in less-than-ideal conditions. The AI model enhances the robustness and reliability of our system by interpreting and making sense of problematic images, ultimately delivering a seamless and user-friendly experience regardless of the condition of the visual markers on the product.

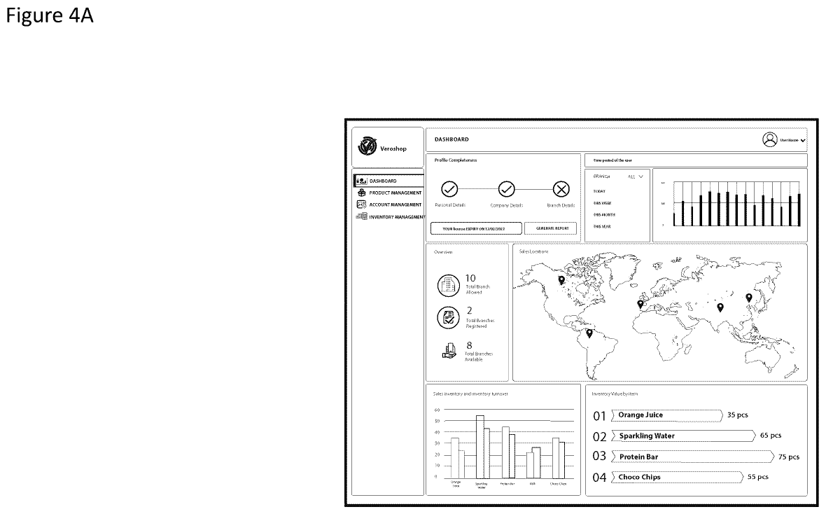

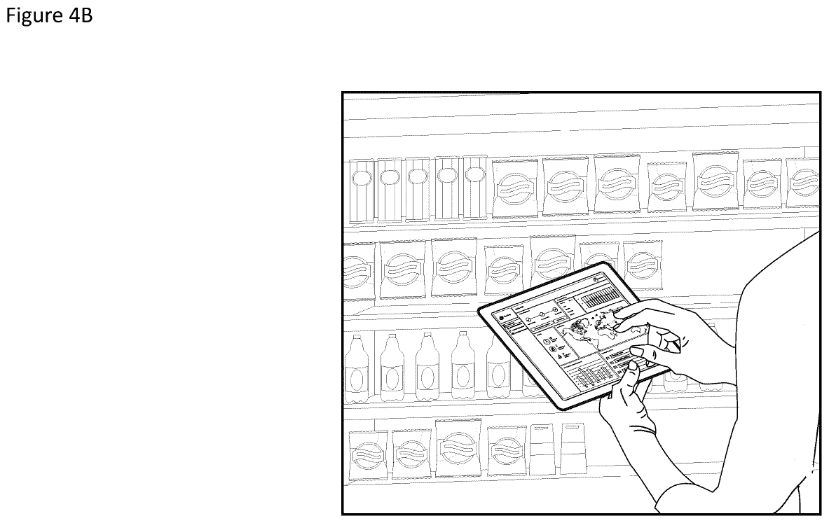

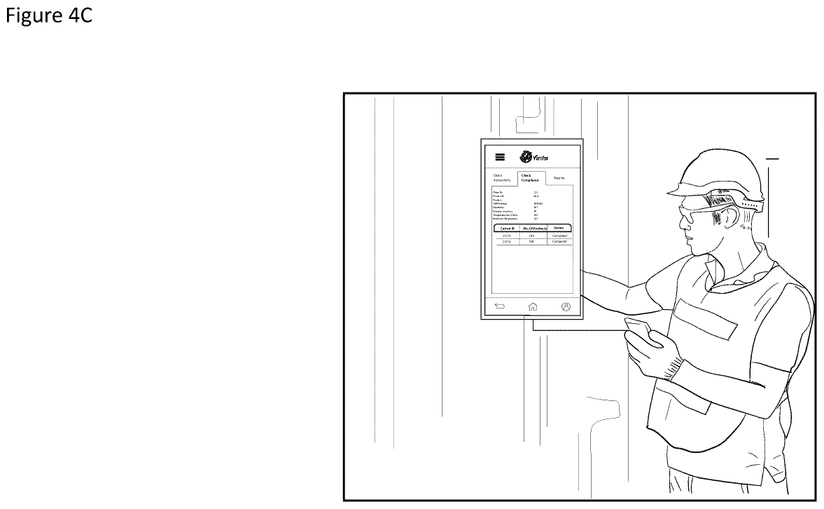

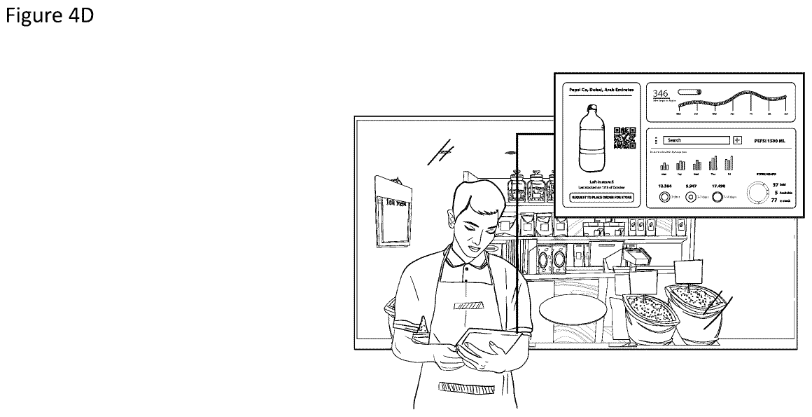

FIGS. 4A-4D show a non-limiting, exemplary flow for interactions with the augmented retail system as described herein, by a retailer for example. FIG. 4A shows a dashboard of information related to the operation of the system. Such a detailed dashboard is preferably reserved for a retailer. Retailers may see analytics and statistical data on inventory, sales, feedback and so forth. Retailers are also preferably able to see insights on the products like highest sold, highest scanned, inventory of the product, consumer comments on the product and/or the store, and so forth, through such a dashboard. FIG. 4B shows how a retailer could use such a dashboard, in combination with a tablet or other device operating an inventory application, to maintain inventory, sufficiently stocked shelves, freshness, attractive product selection and the like.

FIG. 4C shows the retail user (employee of the retailer) viewing the inventory receipt for validating the received order. This scan also enables the order details to be entered into the system, for inventory control purposes, reordering purposes and so forth.

FIG. 4D shows another example of how a retailer could use such a dashboard, in combination with a tablet or other device operating an inventory application, to maintain inventory, sufficiently stocked shelves, freshness, attractive product selection and the like.

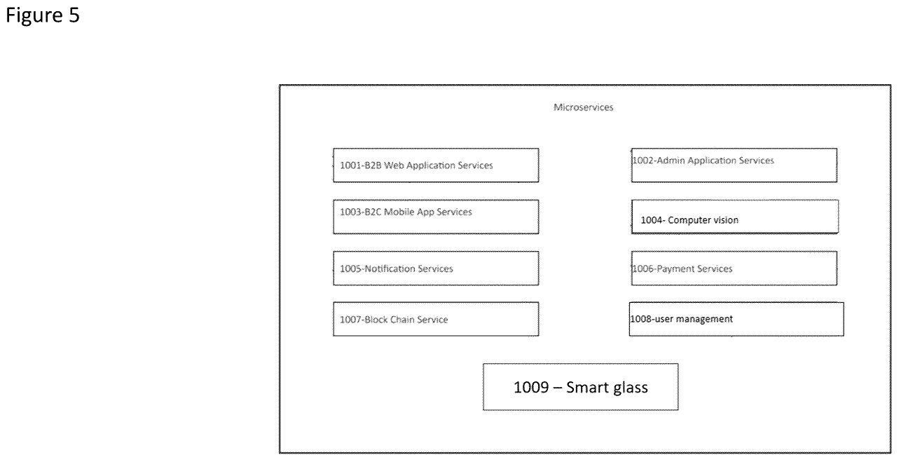

FIG. 5 shows a non-limiting, exemplary set of microservices for supporting the augmented retail system as described herein. As shown, smart glasses 1009 are preferably supported by a suite of microservices, operating at a remote server (not shown). These microservices preferably include a B2B web application service 1001, for example to maintain inventory and other information. A B2C mobile app service 1003 supports the previously described user app interface and other user device services. A computer vision service 1004 supports analysis of images obtained through the user device and optionally also through in-store computer vision technology, for example for security.

A payment service 1006 enables the user to pay for products and to receive an invoice, optionally with a code that may be required to exit the physical premise of a store as described herein.

A blockchain service 1007 enables to be written to, and read from, the blockchain as described herein.

An admin application service 1002 supports administration of the system for managing store and their users. The retailer management includes adding users for different branches, and managing products and inventory.

A user management service 1008 enables users to register, for example to provide preferences, user contact information, payment details and so forth, and then manages these users within the system.

A notification service 1005 may notify the retailer, the user or both, for example with regard to a problem in the operation of the system.

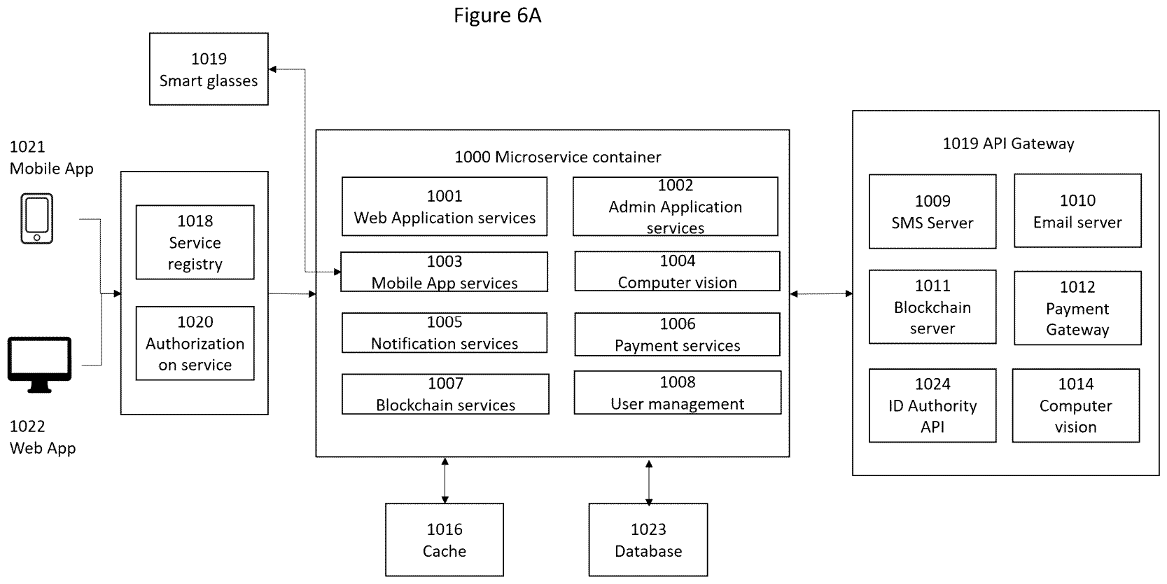

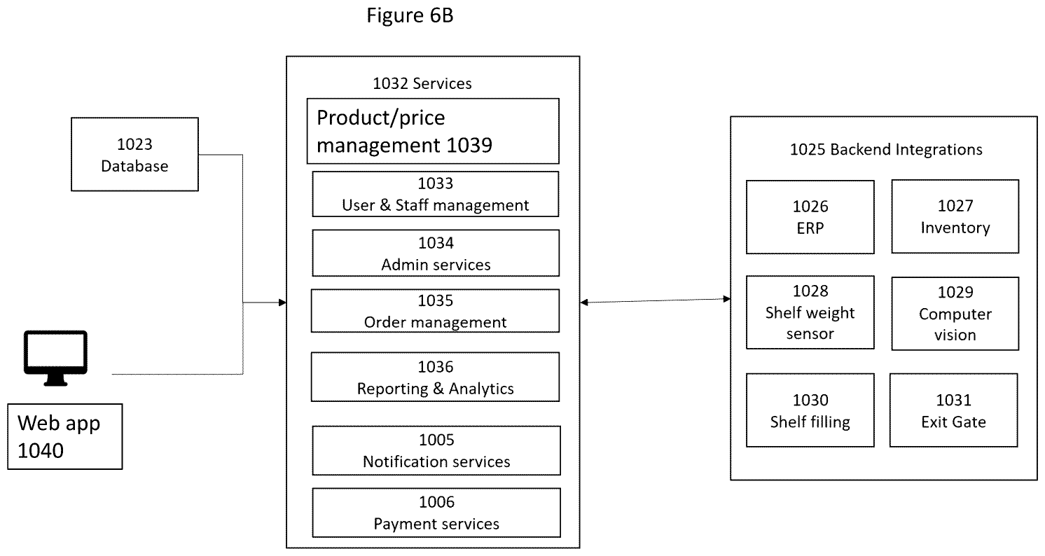

FIG. 6A shows another non-limiting, exemplary system for supporting augmented retail interactions for a product. Microservices 1000 from FIG. 5 are included, and have the same or similar function, in a system 600. Microservices 1000 preferably communicate with a database 1023 and/or locally through a cache 1016, for relevant information that is not stored on a blockchain. The latter data is preferably accessed through communication between blockchain service 1007 and a blockchain server 1011. Blockchain server 1011 may for example comprise a blockchain bridge, to support reading data from and writing data to the blockchain (not shown).

Notification service 1005 optionally communicates with an SMS server 1009, to be able to send and receive SMS (short message service) messages with users of the system. Notification service 1005 optionally also communicates with an email server 1010, to be able to send and receive emails with users of the system.

Computer vision service 1004 preferably communicates with a computer vision API or server 1014 to consume computer vision data, including without limitation image analysis of product images, barcodes, signs, offers and so forth. The analyzed computer vision data may then be used to support the system functions as described herein, for example and without limitation in relation to a request for information from a buyer, a request to purchase a product, transaction information in relation to the product, verification of a physical shopping trolley in comparison to the application cart, and so forth.

Web application services 1001 and mobile app application services 1003 both support payments and transactions, through communication with payment service 1006 and payment gateway 1012. Preferably such services support both retail users and consumers (buyers).

An ID authority API 1024 supports authorization of users, whether retail users or consumers, for the system overall.

An API gateway 1019 may be in contact with microservices container 1000, to provide access to the above servers and/or APIs. For example and without limitation, API gateway 1019 may contain SMS server 1009, email server 1010, blockchain server 1011, payment gateway 1012, computer vision 1014 and/or ID authority API 1024, or a combination thereof.

The user may interact with a mobile app 1021 or with a webapp 1022, which are each supported by a B2B version (for retailers and other commercial users) and a B2C version (for purchasers and consumers). Each of mobile app 1021 and webapp 1022 consumes services through a service registry 1018 and an authorization service 1020, for registering new users and authorizing existing users.

FIG. 6B shows another non-limiting implementation for backend services. A web app 1040 may be used by a retailer to interact with the system as described herein, and also with its own backend retailer platform and/or POS (point of sale) technology, provided as services 1032. Information about sales and other types of data may be stored in a database 1023.

Services 1032 may comprise a product and price management module 1039, for managing inventory and also entering prices. Product and price management module 1039 may rely upon an API connection to an inventory system 1027, as a non-limiting example of backend integrations 1025. A function that is provided through services 1032 and/or backend integrations 1025 may be provided through a combination of an API to a previously existing retailer system and/or additional functionality that is provided through a system as described herein. For example, inventory system 1027 may comprise an existing retail store inventory system. ERP (enterprise resource planning) system 1026 may comprise an existing ERP system, which may then communicate with one or more of user and staff management 1033 to manage both customers (users) and store staff. Store staff are then able to obtain information that enables them to provide personalized service and assistance to customers, for example by scanning their store identifier. The store staff may receive such recommendations and promotions from ERP system 1026, and/or may receive a purchase history from ERP system 1026. ERP system 1026 may further support communication with admin services 1034, for administering sales and operational functions of the store. Order management 1035 preferably provides support for ordering new products, while reporting and analytics 1036 preferably provides reports on sales.

The various integrations between services 1032 and backend integrations 1025 may comprise a combination of technology and data exchange protocols. The integration with the inventory system allows and enables services 1032 to access real-time data about the products available in the store, their locations, pricing, and other relevant details.

Services 1032 preferably also adhere to the store's security protocols and access controls. This ensures that only authorized personnel can access certain information, such as inventory levels, security camera feeds, or alarm systems. Services 1032 may also assist in loss prevention efforts by alerting store security personnel or triggering alarms when it detects suspicious behavior, such as product tampering or unusual movements within the store. For example, shelf weight sensor 1028 and exit gate 1031 comprise services that preferably integrate with existing store systems, to detect when a customer has taken a product off the shelf and/or is attempting to exit the store.

The integration is customizable to fit the specific needs and infrastructure of each retail store. This customization preferably includes compatibility with different point-of-sale (POS) systems, security camera setups, and inventory databases. Computer vision 1029 may connect with an AI model as described herein, and/or with a computer vision as a service platform, to support computer vision functions for these integrations and functions. The integration also preferably includes customer profiles, for example in regard to purchase history and loyalty program information. Such integration may also relate to a CRM (customer relationship management) system (not shown).

FIGS. 7A-7I show another non-limiting, exemplary flow for interactions with the augmented retail system as described herein. FIG. 7A shows an illustration of a user successfully scanning a code of some type, such as a QR code, through smart glasses and/or a smartphone, to be able to enter a physical retail store.

FIG. 7B shows an illustration of a user interacting with the app through the smart glasses. Users may scan a product to see different options like check and trace, offers, learn, view cart, shop and feedback. The check and trace option provides the consumer with information about the origin, provenance, the condition of transport, and different attributes of the product like organic or sustainable or locally produced. Offers are promotional offers that are personalized for that shopper. The learn option enables the user to learn more about the products like its contents, video, infographics, etc., which may be linked to how to use the product to get the best result. View cart enables the user to view the basket of products before they start the checkout process and pay for the goods.

The shop option is invoked when the customer triggers the shopping experience in store, for example to start adding items to their physical shopping trolley and mobile application cart. Feedback enables the consumer to provide feedback upon usage of the product after some time, and/or to provide feedback regarding the condition of the product in the store and/or the store experience. The user is able to select an option through their smart glasses which support touch, voice, head movement, and hand motion.

FIG. 7C shows an illustration of a view through the smart glasses after the user has selected the “learn” option from the previously shown menu. Product information is then shown to the users.

FIG. 7D shows an illustration of a view through the smart glasses for a special purchase offer. While shopping, a user may also get personalized recommendations of products based on their interest, purchase history and preferences, which they may wish to buy.

FIG. 7E shows the view through the smart glasses for verifying a match between a physical shopping trolley and an application cart. Once the desired products are added into the trolley and application cart, the user is able to confirm payment method and proceed to checkout. FIG. 7F shows an illustration of a confirmation message as seen through the smart glasses. Once payment is successful, the user receives a confirmation message and an invoice for the purchase. An invoice is also sent over email as well.

FIG. 7G shows an illustration of the user viewing the invoice and walkthrough QR code received over email. The user may then scan the walkthrough QR code with the smart glasses at the exit gate to leave the store. FIG. 7H shows the user scanning the QR code at the exit gate with a smart phone alternatively or additionally.

FIG. 7I shows an alternative message, indicating that the user needs to complete checkout at a physical checkout counter.

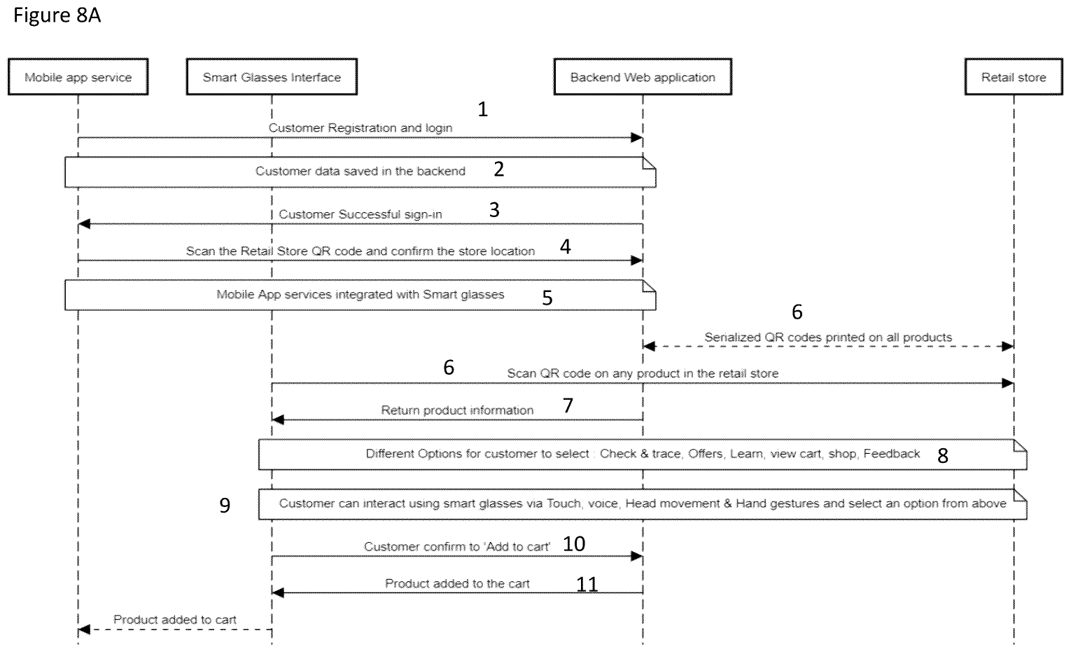

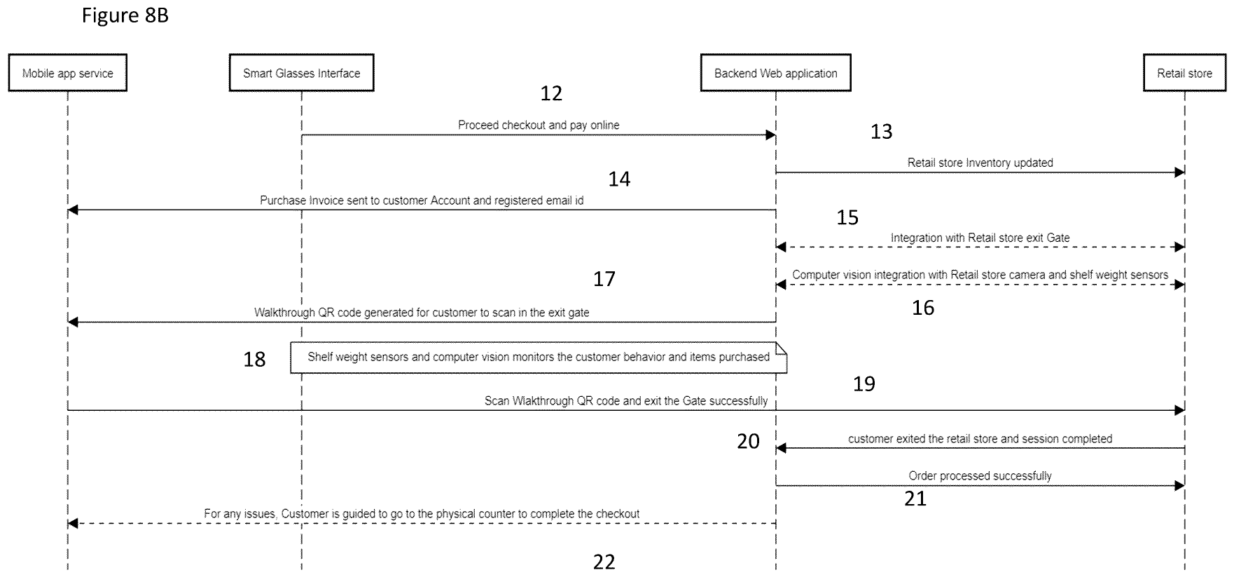

FIGS. 8A and 8B show yet another non-limiting, exemplary flow for interactions with the augmented retail system as described herein. Turning now to FIG. 8A, as shown starting with step 1, the user (retail customer/consumer) registers and logs in, through the mobile app and the backend web application. At 2, the customer data is stored in the backend. At 3, the mobile app receives notification of a successful login process. Once the user wishes to enter a store and to begin shopping, they scan the retail store QR code of the relevant store and confirm the store location. Other processes may be used to confirm that the correct store is being selected, including using smart glasses, another function of the mobile app and so forth.

At 5, if the user has access to smart glasses and has not done so already, the smart glasses are preferably paired with the mobile app, to provide for communication between the smart glasses and the mobile app. At 6, upon entering the store and viewing the products, the user is now notified that they are able to scan these products, with the mobile app, the smart glasses or a combination thereof. The products preferably have a code which may for example comprise a QR code.

At 7, the user decides to scan a product, for example by scanning the QR code on the product with the mobile app, the smart glasses or a combination thereof. In response, the backend web application preferably returns relevant product information as described herein. The smart glasses may communicate directly with the backend. Alternatively, the smart glasses may communicate through the mobile app, which then communicates with the backend. If only the mobile app is present, preferably it communicates directly with the backend.

At 8, the user may select from a plurality of options in terms of product information, such as the previously described check and trace, feedback, receiving offers, learning more about the product, viewing the user's cart and so forth. At 9, the user may use a variety of interaction modalities to interact with the product and the provided product information, including without limitation, gestures, touch, option selection and more.

At 10, the user may select adding the product to the cart which is then confirmed. At 11, the product is indicated as being in the user's mobile app cart, which is also then stored at the backend.

Once the user has finished shopping, then at 12 the user pays and goes through the checking out process. At 13, the store's inventory system is informed of the inventory change, once the user has paid. At 14, also once the user has paid, the purchase invoice is sent to the mobile app and/or an associated user email address. At 15, an integration with the exit gate and security system of the store preferably enables a code to be generated to allow the user to leave with their purchases. A security system at 16 may monitor the user's purchasing activity, for example through an integration with shelf weight sensors and/or computer vision, to make certain that the user has selected the correct product in the correct amount through the mobile app as the user has placed in their physical shopping trolley. Assuming that the security system and purchasing system indicate that the user has purchased the correct products in the physical shopping trolley, then an exit code or other confirmation of exit may be generated at 17.

Optionally, throughout the user's shopping experience, a monitoring process may monitor the products removed from the shelf and placed in the physical shopping trolley, for example through shelf weight monitors and/or computer vision, at 18.

Assuming that the purchasing process has been completed successfully, then at 19, the user scans the exit code and is able to exit the store with their purchases at 20. The backend confirms that the purchase was made successfully at 21. If any problem is encountered by the user during the purchasing process, then at 22 the user is directed to the human operated checkout counter.

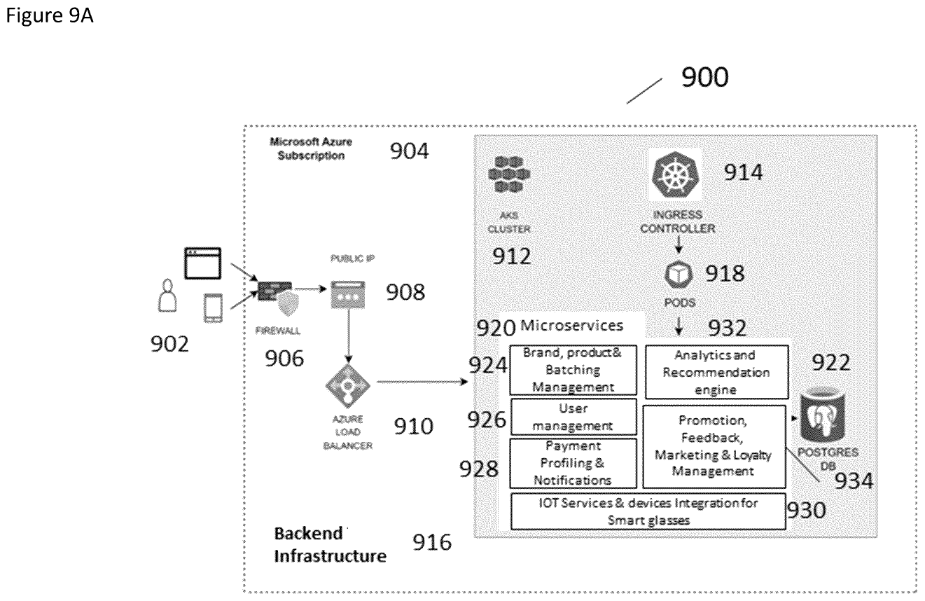

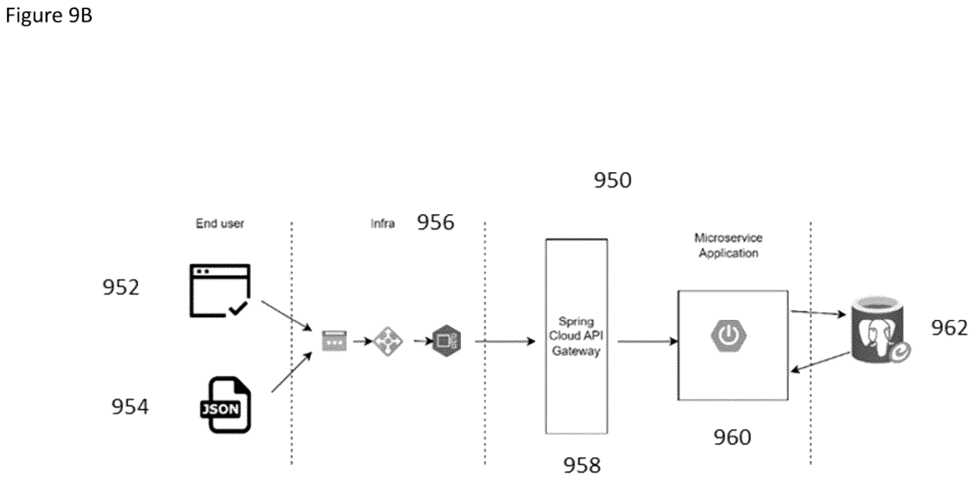

FIGS. 9A and 9B show another non-limiting exemplary system (FIG. 9A) and data flow (FIG. 9B) for interactions with the augmented retail system as described herein. Turning now to FIG. 9A, as shown, a system 900 comprises a user computational device 902 for interacting with a backend infrastructure 916. User computational device 902 enables the user to access personalized retail information, preferably through a retail application as described herein. User computational device 902 preferably comprises the smart glasses as previously described, but may also comprise any suitable computational device (including but not limited to a laptop, smartphone, desktop computer, smart watch, headset and the like) or a combination of such devices. For example, user computational device 902 may comprise smart glasses and a smartphone; the user may view information through the smartphone and/or smart glasses, and may access the personalized application through either or both devices.

Backend infrastructure 916 preferably comprises a cloud based service 904, which supports access of user computational device 902 to a plurality of services through a computer network. In this non-limiting example, the computer network comprises a firewall 906, an IP connection 908 and a load balancer 910. Firewall 906 provides an initial security barrier, intercepting incoming requests and preferably all such requests. Firewall 906 employs specific rules and request patterns configured within it for enhanced security. If an incoming request fails to meet these established criteria, the request is promptly blocked by firewall 906 to prevent potential security risks.

IP connection 908 comprises a public IP address, provide access to microservices 920 through a unified public URL. Load balancer 910 may comprise a plurality of such load balancers, for receiving incoming requests after they have been screened by firewall 906. Load balancer 910 then proceeds to route these requests to the appropriate available servers and/or microservices.

User computational device 902 then preferably accesses a plurality of cloud computing services 912, which may be supported through one or more of AWS of Amazon, Azure of Microsoft, Google Cloud and so forth. Cloud computing services 912 may be implemented through a variety of services and providers. For example, Azure Kubernetes Service (AKS) is a managed container orchestration platform provided by Microsoft Azure. It simplifies the deployment, management, and scaling of containerized applications using Kubernetes, an open-source container orchestration system. Without wishing to be limited by a closed list, AKS may be used as it handles patching, auto-upgrading, monitoring, scaling, and self-healing. This support frees development teams from operational tasks and allows them to concentrate on building services. AKS also supports scaling of applications both by adding more instances and increasing resources for individual containers to meet changing demands.

Azure provides robust security features, including network policies, identity and access management (IAM), and integration with Azure Active Directory, to secure containerized applications. AKS integrates with Azure Monitor and Azure Log Analytics, enabling real-time monitoring, alerting, and logging of containerized workloads.

AKS may also be managed through Azure Arc, to manage and govern AKS clusters across multiple cloud providers and on-premises environments, promoting hybrid and multicloud strategies and AKS integrates with Azure DevOps, Azure Container Registry, and other Azure services, streamlining the development and deployment pipeline.

Cloud computing services 912 preferably comprise a plurality of microservices 920. Access to microservices 920 is preferably controlled by an access controller 914 and a POD (point of delivery) module(s) 918. POD 918 comprises a module of network, computational, storage, and application components that work together to deliver networking services. POD 918 may comprise a plurality of such modules. Data output from microservices 920 and/or to be accessed by microservices 920 may be stored in a database 922.

Access controller 914 preferably serves as the gateway for microservices 920, including registering such services based on path mappings. This component acts as the entry point for incoming traffic to microservices 920. Access controller 914 handles requests coming from the internet or external sources. Services are registered with access controller 914 using specific path mappings. These mappings define how incoming requests should be directed to the appropriate microservice. When a request arrives, access controller 914 examines the URL of the request. Access controller 914 determines which microservice of microservices 920 is to handle the request based on the defined path mapping.

Each such microservice, in turn, runs in a dedicated POD 918 within cloud computing services 912, for example as an AKS cluster. Preferably each POD 918 operates a single microservice, for efficient management and scaling of microservices within the Kubernetes environment.

Microservices 920 preferably comprises a brand, product and batching management module 924. Brand, product and batching management module 924 preferably comprises brand management functions, product management functions and batching functions. Brand management relates to establishing, integrating, and overseeing various brands within global companies. These functions support integration with the necessary ERP systems of manufacturers or brands, acting as an intermediary system that ensures that the system as described herein operates smoothly.

Product management functions focus on the inclusion and management of diverse products under each brand. These functions centralize product-related data, encompassing images, infographics, certificates, allergy warnings, videos, and usage instructions. This comprehensive information enhances understanding and knowledge about each specific product.

Batching functions support serializing products at the item level, offering distinct digital identities for each item. These unique identities ensure unique tracking and identification for individual products, enhancing product identification and management.

Microservices 920 also preferably comprises a user management module 926, for managing users and their relevant personal information, as well as purchasing history, purchasing preferences, interests, security information, payment information and so forth. User management module 926 is responsible for managing user information and access within the system. User management module 926 allows new users to create accounts within the application. This process typically involves providing basic information like username, email, password, their preferences (if any). User management module 926 controls what specific actions and data a user may access within the solution, involves assigning roles and permissions to users, determining who can do what within the system. User management module 926 stores and manages user profiles, which may include personal information, contact details, preferences, and profile pictures. Users may edit and update their profiles as needed. User management module 926 helps record user activity, such as login/logout times and actions performed. This information can be useful for audit trails, troubleshooting, and security monitoring. User management module 926 also preferably sends notifications to users for various purposes, such as account-related updates, alerts, or reminders. User management module 926 also preferably ensures compliance with data protection regulations (e.g., GDPR) and maintains user privacy by handling data responsibly. User management module 926 also preferably supports personalization of staff and other store support and offers, including but not limited to product recommendations.

Payment information may be stored and protected by a payment profiling and notifications module 928, which may be implemented according to a previously described payment system. Payment profiling and notifications module 928 ensures the secure storage and protection of payment information while providing notifications to users. Payment profiling and notifications module 928 securely stores payment information provided by users, such as credit card numbers, bank account details, or digital wallet information. This data is typically encrypted to safeguard it from unauthorized access. To enhance security, sensitive payment data may be tokenized. Tokenization involves replacing the actual payment information with a unique token. The token, which has no intrinsic value, is used for processing transactions, while the actual payment data is stored securely elsewhere. Tokenization adheres to industry and regulatory standards for data security, privacy and compliance. It ensures that payment information is handled in a way that meets the highest security standards.

Users have the option to configure their notification preferences. They may specify how and when they want to receive notifications related to payment activities, such as transaction confirmations, account balance updates, or application notifications and security alerts. Payment profiling and notifications module 928 may trigger real-time notifications to users.

To support communication with specific types of computational devices, microservices 920 may feature specific services for such interactions. For example, microservices 920 may comprise a smart glasses integration 930, which may also support an IoT (internet of things) integration. Smart glasses integration 930 may enhance communication by providing a wearable interface that connects wirelessly. Smart glasses integration 930 preferably enables hands-free interaction, supports voice commands, and displays digital information in the user's field of view. Smart glasses are equipped with sensors, cameras, and displays that enable users to interact with the digital world. They act as a bridge between the physical and virtual environments. Smart glasses are designed to connect wirelessly to various computational devices, such as smartphones, tablets, or wearable computing units. This connectivity may be established through technologies like Bluetooth or Wi-Fi. Smart glasses integration 930 supports the use of such smart glasses by users when interacting with a system as described herein. Smart glasses integration 930 may support interactions with such platforms as VisionOS of Apple Inc, for example.

An analytics and recommendation engine 922 preferably analyzes user interactions with the retail system as described herein, including but not limited to purchasing history, purchasing preferences, interests, previously viewed products, where user interest is focused for physical in-store experiences, coupon use and the like. Analytics and recommendation engine 922 may then suggest products for purchase by the user, which may be sent to user computational device 902. Analytics and recommendation engine 922 may also determine whether a promotion that is sent to the user, for example as a “pop-up” or other indicator at user computational device 902, may result in a sale. Such information is preferably sent to promotion, feedback, marketing and loyalty management module 930, which may then issue a coupon or sale offer, and/or an ad to the user, preferably through user computational device 902.

Analytics and recommendation engine 922 preferably leverages user data, machine learning algorithms, and real-time updates to analyze user interactions and deliver personalized product recommendations. Analytics and recommendation engine 922 preferably continuously refines its recommendations to enhance the user experience and boost engagement. Analytics and recommendation engine 922 preferably first collects extensive data on user interactions, including purchase behavior, and preferences. Analytics and recommendation engine 922 then processes this data to extract valuable insights, such as user preferences, behavior patterns, and product associations. Analytics and recommendation engine 922 preferably creates user profiles based on collected data, categorizing users into segments with similar interests and behaviors. Analytics and recommendation engine 922 preferably employs machine learning algorithms, including collaborative filtering, content-based filtering, or hybrid approaches, to analyze user data and product attributes. Using these algorithms, analytics and recommendation engine 922 preferably generates personalized product recommendations for individual users. Collaborative filtering suggests products based on the behavior of similar users, while content-based filtering considers the attributes of products users have shown interest in.

Turning now to FIG. 9B, a non-limiting, exemplary flow is shown. In a flow 950, the flow preferably begins when an end user 952 interacts with infrastructure 956. End user 952 may interact with infrastructure 956 through the previously described user computational device 902 (not shown). Infrastructure 956 may be implemented as described with regard to FIG. 9A. Such interactions may also include sending a JSON data package 954.

Infrastructure 956 preferably supports microservices 960, which may be implemented as described with regard to FIG. 9A. Access to microservices 960 is preferably provided through an API gateway 958. A database 962 stores the necessary information.

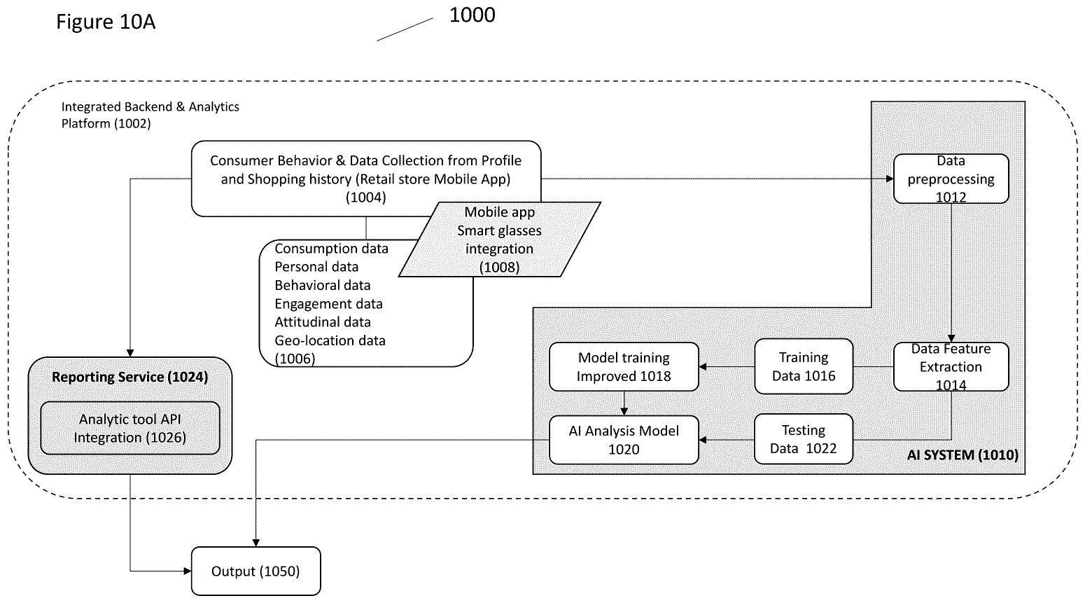

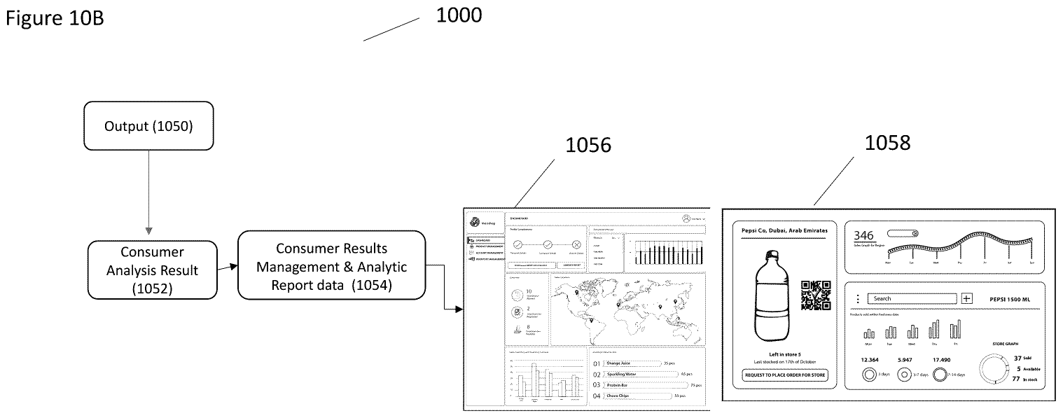

FIGS. 10A and 10B show a non-limiting exemplary system for AI supported retail personalization. Turning now to FIG. 10A, a non-limiting exemplary system 1000 features an Integrated Backend and Analytics Platform 1002, which is in contact with a consumer app (not shown), to collect data about a consumer (user) who purchases products and who interacts with the personalized retail system as described herein. At 1004, consumer behavior data and other types of data are collected, for example from the consumer profile and shopping history. Such collected data is stored at 1006, and may include but is not limited to one or more of consumption (purchase) data, personal data, behavioral data, engagement data, attitudinal data, geo-location data and the like. Preferably, the data is collected through an integration with the consumer app at 1008.

Such collected data is then preferably sent to an AI system 1010. AI system 1010 gathers data from various sources, which may include one or more of structured data from databases, unstructured data from text documents, images, videos, etc. Collected data may need cleaning and preprocessing, which may include tasks like data normalization, handling missing values, and text preprocessing. AI system 1010 may feature a data preprocessing module 1012 to perform such preprocessing functions.

Next relevant features may be extracted from the data to represent key information, for example with a data feature extraction module 1014. Feature extraction may involve techniques such as feature engineering to create meaningful representations. AI system 1010 employs a variety of machine learning models depending on the requirement. Machine learning models may be trained on labeled data or unlabeled data. This process involves optimizing model parameters to make accurate predictions or uncover patterns.

Optionally and preferably, the collected data is split to training data 1016 and testing data 1022. Training data 1016 is used to improve and train the AI model 1020 at 1018. Testing data 1022 is then used to test AI model 1020. If an updated model works better than a previous model, the updated AI model may be deployed. The output of AI model 1020 may be sent to an output 1050. Once trained, AI model 1020 is used for inference, to process new, unseen data and make predictions or classifications based on the patterns learned during training. For image and video data, computer vision algorithms are used to recognize objects, faces, or extract features. These algorithms are helpful for tasks like image classification, object detection, and facial recognition. AI system 1010 may continuously learn and adapt to new data, refining AI model 1020 and/or other AI models, and predictions over time, thereby leveraging the dynamic nature of the collected data. The trained AI model(s) 1020 of AI system 1010 are preferably deployed into production environments, to process real-time data and provide insights, predictions, or automation.

From 1004, the process may also continue to a reporting service 1024, which preferably features an analytic tool API integration 1026. The output of reporting service 1024 may also be sent to output 1050.

Reporting service 1024 preferably provides users with valuable insights and analytics, by integrating with analytic tool APIs, which may include AI-powered capabilities and/or business intelligence software. The integration is supported through analytic tool API integration 1026, and allows reporting service 1024 to offer advanced analytics, intelligent insights, and recommendations. Reporting service 1024 may therefore support data-driven decision-making within the system as described herein. Reporting service 1024 gathers data from various sources within the application, optionally and preferably including user interactions, transactions, and system logs. Reporting service 1024 aggregates and processes this data to create meaningful summaries, statistics, and reports that offer insights into the performance of the system, user behavior, and other key metrics. Reporting service 1024 preferably also provides data visualization features, including charts, graphs, and dashboards. These visual representations make complex data more understandable and actionable.

One or more AI models can be integrated into reporting service 1024 to provide intelligent insights. AI can also offer recommendations based on data analysis.

Turning now to FIG. 10B, system 1000 continues, showing output 1050, which preferably features an analysis of consumer behavior and data at 1052. This analysis is then preferably further output as a Consumer Results Management and Analytic Report 1054. The analysis results may be displayed as shown in dashboards 1056 and 1058.

Consumer Results Management and Analytic Report 1054 preferably enables the retailer to manage and analyze consumer data. Consumer Results Management and Analytic Report 1054 supports understanding consumer behavior, optimizing marketing strategies, and delivering personalized experiences. Consumer Results Management and Analytic Report 1054 may also support improvement of products and services by providing actionable insights derived from consumer interactions and data analysis. Consumer Results Management and Analytic Report 1054 gathers extensive data related to consumer interactions, behaviors, and preferences. This data may include but is not limited to one or more of purchase history, product reviews, feedback, and demographic information. By leveraging machine learning algorithms, Consumer Results Management and Analytic Report 1054 may be used to generate personalized product recommendations for individual consumers. These recommendations are based on their past interactions and preferences. Consumer Results Management and Analytic Report 1054 also preferably generates detailed analytic reports that offer actionable insights. These reports can be customized to focus on specific metrics, time frames, or consumer segments. Visual representations, including charts, graphs, and dashboards, help retailer users interpret the data more easily and make informed decisions.

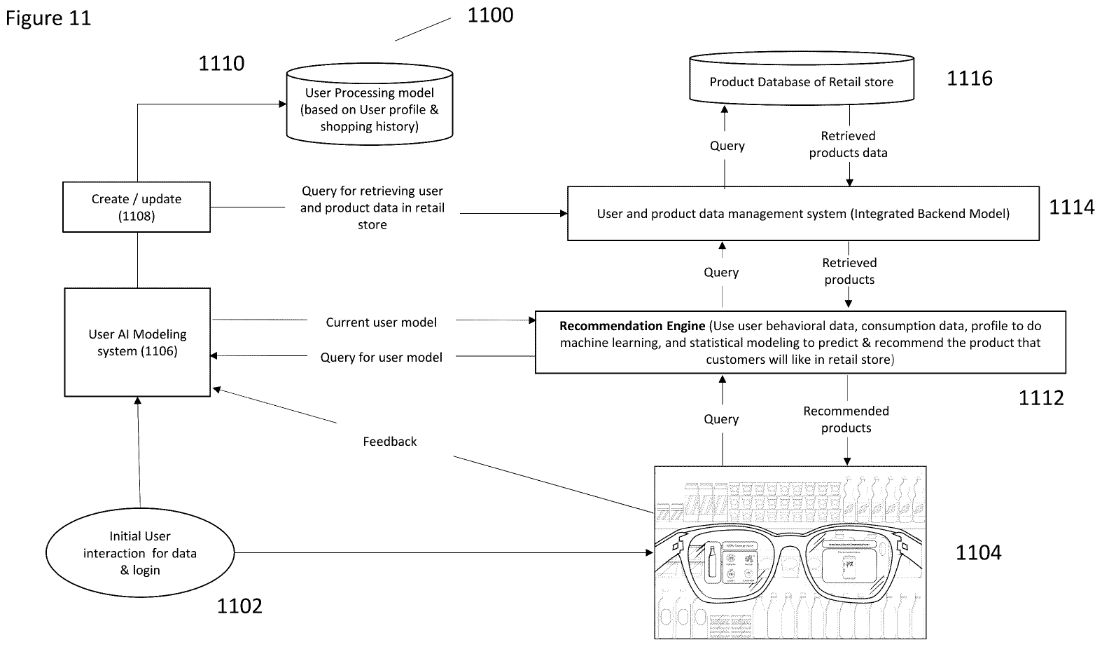

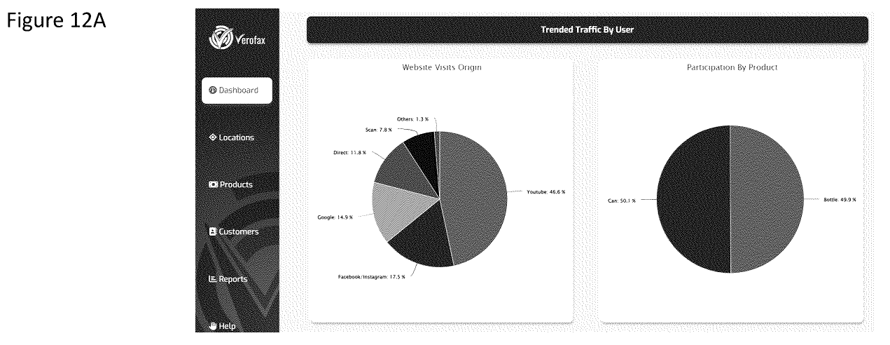

FIG. 11 shows a non-limiting, exemplary flow for interactions with the augmented retail system as described herein. As shown in a flow 1100, the flow begins with an initial user interaction with the personalized retail system as described herein, at 1102. Such an interaction may occur through a user computational device and app as described herein, which may comprise smart glasses 1104 as shown. Information from such interactions is preferably fed to a user AI modeling system 1106, which may be trained as previously described. A user profile and associated information may be created or updated at 1108, based on user interactions with the retail system and/or output from AI modeling system 1106 as shown, such that a user profile model may be output at 1110.

User AI modeling system 1106 comprises a data-driven engine that continuously creates and updates user profiles based on their interactions. User AI modeling system 1106 uses machine learning to analyze behavior, predict preferences, and deliver personalized experiences. User AI modeling system 1106 enhances user engagement, drives conversions, and fosters a deeper understanding of user needs and interests, for example by providing an immersive retail experience to the user, product recommendations, particular product information which may be of interest to the user (for example regarding sustainability). User AI modeling system 1106 starts building user profiles by assigning attributes and preferences based on observed interactions. User AI modeling system 1106 preferably leverages user profiles to personalize content recommendations. User interactions with personalized content and recommendations provide valuable feedback to user AI modeling system 1106. This feedback loop helps refine user profiles and improve the accuracy of predictions.

In order to obtain the necessary data and information, preferably the user interacts with the retail system. For example, smart glasses 1104 may be used to query a recommendation engine at 1112. The recommendation engine preferably also has access to user behavioral data, consumption data, profile to do machine learning, and statistical modeling to predict and recommend the product that the consumer is likely to want. The recommendation engine may receive such data directly and/or may be in contact with AI modeling system 1106, which may provide such information and recommendations.

Recommendation engine 1112 is also preferably in contact with the previously described user and product data management system (Integrated Backend Model) at 1114. This system is preferably in turn able to access product information from the product database of the retail store at 1116.

Recommendation engine 1112 preferably predicts products consumers are likely to want through the combined power of AI techniques. Recommendation engine 1112 preferably analyzes user behavior, creates user profiles, and employs collaborative filtering, content-based filtering, and deep learning to generate personalized product recommendations.

Recommendation engine 1112 preferably continuously evolves to deliver more accurate and engaging recommendations, enhancing the overall user experience.

User and product data management system 1114 in turn preferably accesses product information from the retail store's product database through integration, APIs, structured queries, and real-time updates. This data retrieval process at 1116 ensures that users have access to accurate and up-to-date product details, enabling a smooth and efficient shopping experience.

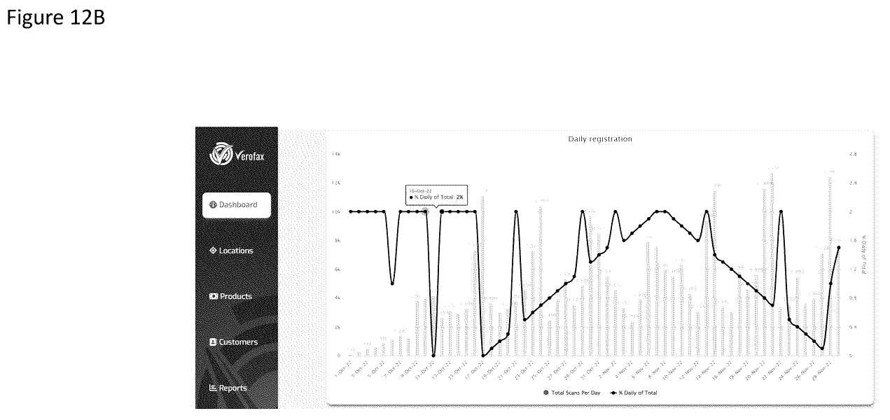

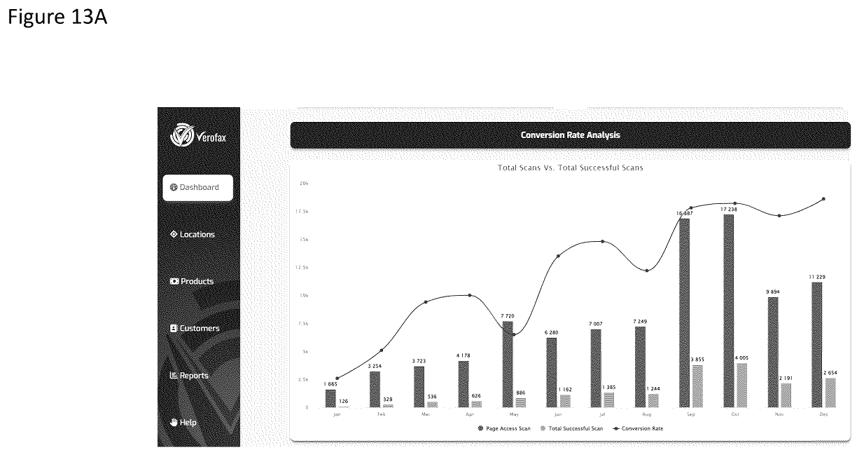

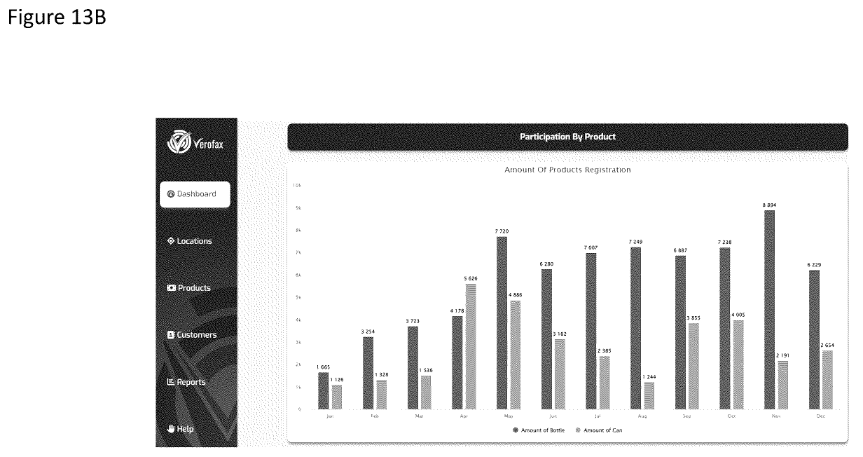

FIGS. 12A-13B show non-limiting, exemplary dashboards for analyzing AI supported retail personalization.

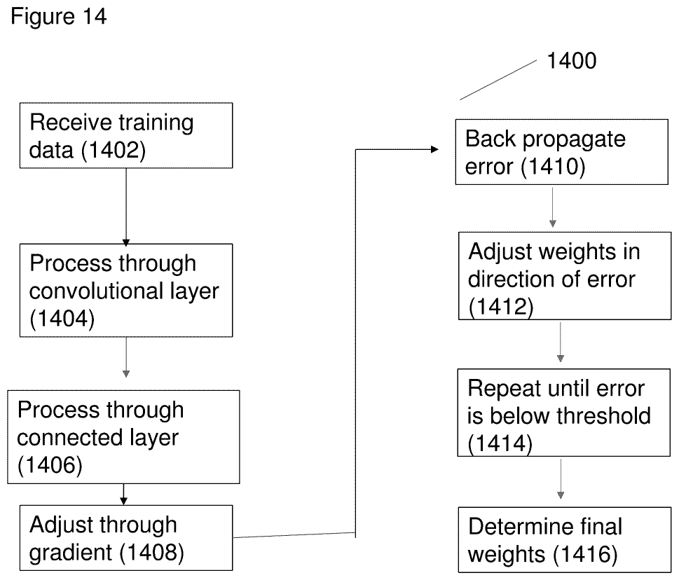

FIG. 14 shows a non-limiting, exemplary method for training an AI model. A method 1400 is shown for training a machine learning model, which in this non-limiting example may comprise, for example, a CNN. One of ordinary skill in the art could adjust the training process for other types of machine learning models and/or other types of AI models. The method is preferably deployed for determining personalization for a user (consumer), for example and without limitation, in regard to purchasing preferences, special and/or instant offers to be made in the store and so forth. An instant offer is one that is made while the user is in the store, and preferably while the user is at, near, walking to or from, or walking by, a particular area or location of the store, such as a particular shelf, rack, display case and so forth.

At 1402, data relating to previous consumer data, for any particular consumer but preferably for a plurality of such consumers, is provided. The data may be labeled with whether a purchase occurred, consumer habits, changes in purchasing behavior, reaction to coupons, reaction to special or instant offers, or some combination thereof.

The data may relate, additionally or alternatively, to images of a QR code or other visual markers for identifying a product. Preferably such images further comprise images in which such QR codes or other visual markers on products are damaged or obscured. Furthermore, such images also preferably have different backgrounds and angles. Such different types of images enable the trained AI model to leverage advanced image recognition and reconstruction techniques. It can analyze the available visual data, even if it's incomplete or distorted, and intelligently reconstruct the code and/or visual markers to the best of its ability.

At 1404, the data is processed through the convolutional layer. At 1406, it is processed through the connected layer. Adjustments are made through the gradient at 1408. The error is calculated, in regard to whether the model is able to correctly process the labeled data to provide the desired outcome, such as positively influencing consumer behavior. A positive influence may comprise one or more of making an additional purchase, purchasing a new brand or good, upgrading a purchase (for example, to a higher price product or brand), purchasing more often and so forth. This error may then be backpropagated through the model at 1410. The weights may be adjusted in the direction of the error at 1412. Other types of training methods are known; for example, two forward algorithms may be used in place of, or in addition to, back propagation. One of the forward algorithms may comprise positive labeled data; that is, data that the model should correctly analyze. The other forward algorithm may comprise negative labeled data, which indicates to the model what not to do. A non-limiting example of such an algorithm is described by Geoffrey Hinton in “The Forward-Forward Algorithm: Some Preliminary Investigations” (preprint published by the Department of Computer Science, University of Toronto; Dec. 14 2022).

At 1414, the process of 1404-1412 is preferably repeated until the error is below a desired threshold. At 1416, the final weights are determined.

The above described AI models preferably also interact with the above described blockchain or DLT systems. The interaction between AI (Artificial Intelligence) and blockchain systems supports collecting and processing data, and AI driven insights. AI algorithms within the system collect and process data from various sources, including user interactions, sensor data, external databases, or blockchain. In that respect, as long as the AI engine (or model) is able to access the data, for example through a gateway, server and/or API, retrieving data from, or writing data to, blockchain may be provided along with access to other data sources. This data may include user preferences, behavior patterns, or transaction records. AI analyzes this data to generate valuable insights, such as personalized recommendations, predictive analytics, or anomaly detection. These insights can enhance user experiences and improve decision-making processes.

Blockchain technology may be integrated into the system as described herein to securely store and manage critical data, transactions, and smart contracts. The blockchain acts as a decentralized ledger that records all relevant interactions and transactions. Data generated by the AI, such as recommendations or predictions, may be timestamped and recorded on the blockchain. Recording such data creates an immutable record of AI-driven decisions and actions, ensuring transparency and auditability. The decentralized nature of blockchain enhances system resilience and eliminates single points of failure, making it more robust for handling AI-generated data and transactions.

The interaction between AI and blockchain systems enhances data security, transparency, and trust while enabling intelligent decision-making and automation. This combination can create a more efficient, secure, and user-centric system, in applications involving various data or transactions.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A system for personalized retail experience based on artificial intelligence (AI), comprising a user computational device for obtaining user interaction data; a server for receiving said user interaction data from said user computational device; and an AI model in the server for analyzing said user interaction data and generating personalized retail recommendations; wherein said AI model is trained using historical user interaction data and purchase history data; and wherein said personalized retail recommendations are generated for an in store experience for a physical store, when said user computational device is located within said physical store.

2. The system of claim 1, wherein said user computational device comprises smart glasses, a smartphone, or another mobile device, or a combination thereof, for viewing information and accessing a personalized retail application for viewing said personalized retail recommendations.

3. The system of claim 2, wherein said user computational device comprises a user interface for displaying said personalized retail recommendations, and wherein said user interface is a mobile application that communicates with the server to receive said personalized retail recommendations.

4. The system of claim 3, wherein said user interaction data includes one or more of user browsing history, user search queries, user product views, user product ratings, physical store product interactions, physical store product views, physical store product returns and user purchase history.

5. The system of claim 4, wherein said AI model uses machine learning algorithms to analyze said user interaction data and generate said personalized retail recommendations.

6. The system of claim 5, wherein said personalized retail recommendations include product recommendations, personalized discounts, and personalized product bundles.

7. The system of claim 4, wherein said AI model is further trained using demographic data of the user.

8. The system of claim 7, wherein said demographic data includes one or more of user age, user gender, user location, and user preferences.

9. The system of claim 4, wherein said AI model is further trained using external data sources, including market trends, seasonal trends, and product trends.

10. The system of claim 4, wherein said user computational device further comprises a feedback mechanism for the user to rate the relevance of said personalized retail recommendations.

11. The system of claim 10, wherein said feedback is used to further train and refine said AI model.

12. The system of claim 4, wherein said AI model comprises a deep learning model.

13. The system of claim 12, wherein said deep learning model comprises a neural network.

14. The system of claim 13, wherein said neural network is a convolutional neural network.

15. The system of claim 4, wherein said server is implemented as a backend infrastructure, wherein said backend infrastructure comprises a cloud-based service, which supports access of user computational device to a plurality of services through a computer network; wherein said backend infrastructure further comprises a plurality of microservices, including a brand, product and batching management module, a user management module, and a payment profiling and notifications module.

16. The system of claim 15, wherein said microservices further comprise a smart glasses integration module, which supports interaction with smart glasses for said user computational device.

17. The system of claim 16, wherein said smart glasses integration module supports interaction with a smart glasses hardware platform.

18. The system of claim 15, wherein said personalized retail recommendations include product recommendations, personalized discounts, and personalized product bundles.

19. The system of claim 15, further comprising an ERP system integration, wherein said ERP system integration supports retail store staff interactions.

20. The system of claim 15, wherein said server further comprises at least one microservice for supporting personalized user interactions.
